(19) United States
(12) Patent Application Publication
(10) Pub. No.: US 2025/0083574 A1
(43) Pub. Date: Mar. 13, 2025

(54) RAIL ASSEMBLY WITH A COVER DEVICE, AND VEHICLE

(71) Applicant: Adient US LLC, Plymouth, MI (US)

(72) Inventors: Ingo QUAST, Düsseldorf (DE); Erik SPRENGER, Wermelskirchen (DE)

(21) Appl. No.: 18/721,246

(22) PCT Filed: Dec. 20, 2022
(86) PCT No.: PCT/IB2022/062518

§ 371 Date: Jun. 18, 2024

(30) Foreign Application Priority Data
Dec. 22, 2021 (DE) 10 2021 214 870.0
Mar. 15, 2022 (DE) 10 2022 202 546.6
Jun. 2, 2022 (DE) 10 2022 205 667.1

(51) Int. Cl. B60N 2/07

(52) U.S. Cl. CPC B60N 2/0725

(57) ABSTRACT

A rail assembly for a longitudinal adjuster of a vehicle seat may have at least one first rail, a second rail which is movably arranged relative to the first rail, and a cover device for covering a rail opening of the first rail. The cover device may be arranged on a rail end of the first rail and may have at least one cartridge and a cover element which is received in the cartridge and which can be rolled up. A first cover element end which is guided or can be guided out of the cartridge is connected to or can be connected to the second rail. Additional rail assemblies which have at least one first rail, a second rail that is movably arranged relative to the first rail, and a cover device for covering a rail opening of the first rail may be used.

The invention relates to a rail assembly with a cover device for covering a rail opening. Furthermore, the invention relates to a vehicle having such a rail assembly.

### PRIOR ART

DE 10 2016 224 588 A1 discloses a longitudinal adjuster having a rail assembly, comprising a lower rail and an upper rail, which is movably connected to the lower rail. Also disclosed is a cover (e.g. a rubber cover, a brush cover, etc.) which is connected to an outer profile of the lower rail and which is arranged in such a way that it covers at least part of an inner profile. The cover may comprise a rubber strip which is connected to the outer profile and is arranged on an upper part of each side of the inner profile. The cover may generally extend parallel to a longitudinal axis of the inner profile. The cover covers at least part of the corresponding intermediate spaces in the lower rail. The cover is designed to restrict/prevent dirt and/or fabric from penetrating or dropping into corresponding intermediate spaces in the lower rail.

EP 1 209 024 A1 and EP 1 207 073 A1 disclose longitudinal adjusters for a vehicle seat, which have a lower rail fastened to a vehicle floor and an upper rail attached displaceably to the lower rail. The longitudinal adjusters have a cover panel, which is formed from a synthetic resin material and has two soft lip portions, which form a gap, on an inner side.

JP H10-315 809 A discloses a longitudinal adjuster for a vehicle seat, which has an elongate lower rail, which is fastened to a vehicle floor, and a seat-side upper rail, which is attached displaceably to the lower rail. On an upper surface of the lower rail, two elastic coverings are provided, which are loosely adjacent to each other on the longitudinal side and through the contact gap between which the upper rail passes. Further longitudinal adjustment devices having coverings are known, for example, from DE 10 2021 200 264 A1, WO 2022/084768 A1 or DE 10 2107 209 452 A1.

### Problem

The invention is based on the problem of specifying a rail assembly having an improved cover device for covering a rail opening, in particular a resistant and easy-to-install cover device, which prevents the penetration of dirt bodies or other interfering bodies into the rail opening. The invention is further based on the problem of improving a longitudinal adjuster for at least one vehicle seat in a vehicle, in particular a longitudinal adjuster having an improved cover device for covering upwardly open regions of a rail of the longitudinal adjuster, wherein the cover device completely prevents the penetration of dirt bodies or other interfering bodies and is easy to install. The invention is further based on the problem of providing a vehicle having such a longitudinal adjuster.

### Solution

With regard to a rail assembly, the problem is solved according to the invention with the specified features of claim 1.

With regard to a longitudinal adjuster, the problem is solved according to the invention with the specified features of claim 14.

With regard to a vehicle, the problem is solved according to the invention with the specified features of claim 15.

Advantageous refinements, which may be used individually or in combination with one another, are the subject matter of the dependent patent claims.

A rail assembly according to the invention for a longitudinal adjuster of at least one vehicle seat comprises at least one first rail, one second rail, which is arranged displaceably relative to the first rail, and a cover device for covering a rail opening of the first rail, wherein the cover device comprises at least one cover element, which closes the rail opening at least in sections upon a movement of the second rail relative to the first rail, wherein an interface is provided between the cover element and the second rail for automatically coupling the cover element to the second rail, wherein the interface is designed in such a way that the cover element and the second rail couple to each other during coupling to each other under preload and/or, after coupling has taken place, remain or are coupled to each other, under preload.

The advantages achieved with the invention consist in particular in the fact that, during or after installation of the cover element and the second rail with each other, a preload is achieved, which permits a fixed connection of the cover element, in particular of a roller spring. In addition, such a preload enables a homogeneous cover surface without undulations or creases.

An alternative embodiment of a rail assembly for a longitudinal adjuster of a vehicle seat comprises at least one first rail, one second rail, which is arranged displaceably relative to the first rail, and a cover device for covering a rail opening of the first rail, wherein the cover device is arranged at a rail end of the first rail and comprises at least one cassette and a cover element, which is received in the cassette and can be rolled up, wherein a first cover end of the cover element which is able to be led or is led out of the cassette is connectable or connected to the second rail. Such a cassette may also be provided in the rail assembly according to the invention.

The cover element (independently of the embodiment of the rail assembly) is connectable or coupleable to the second rail during installation, i.e. before a final installation. After installation, the cover element is releasably connected or coupled to the second rail, for example. In a stowed state of the cover element, the latter is completely accommodated in the cassette. If the second rail moves in a direction away from the cassette, the cover element can be led, in particular pulled, further out of the cassette in order to close, in particular to cover, the rail opening of the first rail in sections.

The advantages achieved with the invention consist in the fact that such a cover device, in particular in the form of a cassette, can be provided and installed in a simple manner. In addition, the cassette is designed to save on space. The cover device is compact. The number of parts of the cover device is reduced. The cassette is in the form of a housing, for example a plastics housing and/or metal housing.

The cassette may be positioned in a space-saving manner at one end of the first rail or rail assembly. The cassette may, for example, have an opening, in particular housing opening, through which the first cover end is able to be led or is led out in a simple and uncomplicated manner.

The cover element may be in the form of a preloaded roller spring for all of the embodiments. The cover element may be designed as a spring element which can automatically be rolled in. A spring force of the cover element causes, for example, a rolling-in action. By movement of the second rail in a direction counter to the spring force, in particular in a direction away from the cassette, the cover element can be extended, in particular rolled out. The cover element may be preloaded.

The cover element may be in the form of an element which can be rolled up or rolled in. For example, the cover element may be arranged within the cassette so as to automatically roll in or automatically roll up.

The cassette may comprise at least one holding device by which a second cover end of the cover element is rotatably fastened or mounted within the cassette. The second cover end may be mounted rotatably within the cassette. The holding device may be designed, for example, as a rotatable bearing element, winding element or rolling element. For example, the holding device may have a holding protrusion, a latching nose or a holding groove. The second cover end may be mounted or applied, in particular clamped, in a form-fitting manner to the holding protrusion, in the latching nose or in the holding groove. The cover element may roll up, in particular wind up, in a rolling-up direction around the holding device, and may unroll in an unrolling direction opposed to the rolling-up direction.

The interface may be provided between the cover element and the second rail, wherein the interface may be designed to automatically couple the cover element to the second rail, for example, during installation. The interface may be in the form of a direct interface, wherein the second rail can enter into coupling with the cover element directly and without additional separate connecting elements and/or fastening elements, such as separate screws. The interface may comprise a pair of clamping means either at a first cover end of the cover element or at a rail end of the second rail. A first interface at the first cover end may have, for example, as a pair of clamping means, two clamping surfaces, for example tabs protruding laterally from the roller spring end, which protrude laterally over the rail end of the second rail in the transverse direction of the rail assembly, both in the installed state of the second rail and cover element in the first rail and also in the uncoupled state of the cover element and the second rail.

For example, during the coupling (upon coupling or as coupling is taking place) or in the coupled state of the cover element and the second rail, the two clamping surfaces engage laterally in the second rail in such a way that the cover element and the second rail are coupleable to each other, or remain coupled or are coupled, under preload. For example, the cover element and the second rail may be coupled to each other under preload in the coupled state by the clamping surfaces in such a way that a belt region of the cover element is in the form of an upwardly projecting curved surface. Thus, a cover surface of the roller spring covering the rail opening comprises a homogeneous cover surface without undulations. In other words: the cover element is formed substantially without creases in a state covering the rail opening.

The first interface may be formed, for example, by two tabs bent over laterally from a cover portion or the cover surface of the first cover element.

Alternatively or additionally, a second interface at the rail end may have, as a pair of clamping means, two clamping contours which both in the installed state and in the uncoupled state of the cover element and the second rail, protrude over the cover element in the vertical direction, in particular upward beyond the cover surface. During the coupling or in the coupled state of the cover element and the second rail, the two clamping contours engage from below in the cover element in such a way that the cover element and the second rail are coupleable to each other, or remain coupled or are coupled, under preload.

The respective interface may comprise at least one coupling element and a mating coupling element, wherein a cover end can be provided with the coupling element and a rail end of the second rail facing the cover end may be provided with the mating coupling element.

Alternatively or optionally additionally, at least one centering element for aligning the cover element relative to the second rail during installation may be arranged at the first cover end of the cover element. The centering element may be designed to center/align the cover element relative to the second rail, in particular to a rail end of the second rail. Coupling, in particular automatic coupling, can thereby be simplified.

The interface may be in the form of a direct interface, wherein the second rail can enter into coupling with the cover element directly and without additional separate connecting elements and/or fastening elements, such as separate screws.

The interface may have a number of corresponding latching elements, which enter into a releasable latching engagement during the installation. The latching elements may be, for example, latching receptacles and corresponding latching hooks.

The rail assembly may comprise a lower rail as the first rail and an upper rail or a rail runner as the second rail. The second rail is held guided into an interior of the first rail, wherein the cover device is provided for covering the rail opening of the first rail, the cover device having a panel with a panel opening, wherein the cover device is arranged on the first rail in such a way that the rail opening of the first rail and the panel opening lie one on top of the other, wherein the panel opening is closable at least in sections by a cover element which is guided in a guide channel of the panel and can be rolled up, and a free movable cover end of the cover element has a coupling element, and the second rail at a rail end facing the free movable cover end of the cover element has a mating coupling element for automatically coupling to the coupling element during installation.

The invention is based on the consideration that, when the rail assembly is installed in the vehicle, in particular on a vehicle floor, the cover device has to be opened to gain access to fastening points in the first rail, in particular in the lower rail, for the fastening to the vehicle floor, wherein the cover element has to be raised manually after the lower rail is fastened to the vehicle floor. This may damage both the guide channel and the cover element.

The advantages achieved with the invention consist in particular in that a direct interface between the cover element and the second rail is formed by the coupling element of the cover element and the mating coupling element of the second rail, in particular the upper rail. In particular, this direct interface permits automatic coupling. Said automatic coupling is carried out without tools. This permits particularly simple installation. In addition, damage to the guide channel is avoided. Also, such a direct interface or coupling has a short constructional form. The cover element, which is arranged rolled up in the cover device before the installation of the second rail, may have a continuous curved surface.

An alternative embodiment of a rail assembly may comprise at least one first rail, one second rail, which is arranged displaceably relative to the first rail, and a cover device for covering a rail opening of the first rail, wherein the cover device comprises at least one cover element, which closes the rail opening at least in sections upon a movement of the second rail relative to the first rail, wherein at least one centering element for aligning the cover element relative to the second rail during installation is provided at a cover end of the cover element.

For all embodiments, the first rail may comprise the cover device with the cover element for covering one of the rails of the longitudinal adjuster. For all embodiments, the cover device may have a panel with an opening, wherein the opening is closable at least in sections by at least one cover element guided in the panel. The cover end is a freely movable end of the cover element.

Owing to the fact that the cover device has a panel with an opening, and the opening is closable at least in sections by a cover element which is guided in a guide channel of the panel and can be rolled up, a variable covering of a rail disposable below the panel can be made possible. Owing to the fact that the cover element is guided in a guide channel of the panel, a lateral closure of the opening of the panel, and a load-bearing capacity of the cover element from above, is ensured. In particular, this does not allow any dirt bodies or other interfering bodies to be pushed through the covering.

The centering element at the free cover end of the cover element can also make it possible for the second rail to be installed and connected in a simple manner without tools and automatically to the cover element. For example, during a movement of the second rail relative to the first rail, for example during installation or during conventional use of the second rail, for example during an adjustment of a seat, the cover element can be guided centered in the second rail in the transverse direction or Y direction (Y centering) by the centering element.

In particular, the cover element is guided centered in the transverse direction by the centering element during a movement in the longitudinal direction, in particular for covering the rail opening.

The movement of the second rail relative to the cover device is in particular an insertion movement and coupling movement or installation movement of the second rail in or along the cover device or vice versa. In this case, the second rail or the cover device can be moved as far as an end stop, wherein the second rail and the cover device are coupled or connected to each other before or at the latest when the end stop is reached.

In an installed state, the centering element can be arranged within a receiving space formed by the second rail and connected to the second rail in a form-fitting and/or force-fitting manner.

The centering element may be in the form of a bent-over tab, lug or tongue. The centering element may be formed integrally with the cover end of the cover element. The cover end may have a region formed or deformed into the centering element. The centering element may be integrally formed on or in the cover end. The centering element may be in the form of a separate part and connected to the cover end of the cover element in a force-fitting, materially bonded and/or form-fitting manner. The centering element may be formed protruding from the cover end.

For example, the second rail may have a shape-complementary and function-complementary inner side with respect to the centering element or the centering elements. The centering element may be, for example, in the form of two bent-over tabs, lugs or tongues. In particular, the respective tab, lug or tongue is in the form of a region or section separated from the cover element by a longitudinal section and bent over. The tabs may be bent 30 inward, when the cover element is viewed in cross section. For example, the tabs are bent inward about 85°. As a result, the tabs lie preloaded on the inner sides of the second rail in the assembled state or in the coupled state of the cover element and second rail.

The centering element may comprise a coupling element, wherein the second rail, at a rail end facing the centering element of the cover element, may have a mating coupling element for automatically coupling to the coupling element during installation.

The cover element and the second rail may have interacting connecting elements, in particular corresponding latching receptacles and latching protrusions or latching recesses and latching noses, which latch together before or at the latest when the front end stop is reached. This enables a simple and tool-free form-fit connection between the longitudinal adjuster and the cover device.

The panel may be a plastics panel. The panel may be a metal panel. A guide channel for guiding and holding the cover element may be arranged to the side of the opening, in particular on both sides of the opening. A guide channel for guiding and holding the cover element may be arranged on both sides of the opening. The guide channel in the panel may be slot-shaped. The guide channel can receive and guide an edge portion of the cover element in sections.

The opening is closable in sections with the cover element guided in the panel. By covering of the opening at least in sections by the cover element, a view of a spindle, which is arranged in the interior of the first rail, of an electrical adjustment can be prevented, for example.

The cover device may have a first cassette at a rear end. The cover device may have a second cassette at a front end. Preferably, the cover device has a first cassette at a rear end and a second cassette at a front end. The cover element may be provided in the first cassette. A second cover element may be provided in the second cassette. The cover element may be rolled in in the respective cassette. The opening of the panel may extend to sections above the first or second cassette. The panel may be closed in sections above the first or second cassette, and therefore a portion of the cover element rolled up in the cassette is concealed. The cover element in the cassette may be protected from external loading and/or damage. The panel may have a scraper element in a transition region to a cassette. The scraper element may have a brush. The scraper element may be in contact with a surface of the cover element. The scraper element can prevent dirt from entering the cassette.

The cover element may be spring-elastic. The cover element may be a constant force spring, for example a roller spring. A first end of the cover element may be connected to the second rail. A second end of the cover element may be connected to a holding device in the cassette assigned to the cover element or may be arranged captively in a housing. In particular, the cover element is mounted captively in the cassette when rolled up and as it is being unrolled or rolled up. For this purpose, the cover element has such a length and/or the cassette, at least on the inside, has such a shape and/or dimensions, that the cover element can be arranged rolled up in the cassette, and, in the case of a force loading, in particular tensile loading, of the free first end of the cover element for unrolling or, in the case of a force loading, in particular a restoring force, of the cover element for winding up the cover element again, the latter is arranged, in particular mounted, captively in the cassette.

Alternatively or additionally, the cover element, in particular the second end of the cover element, may be held in the cassette by a holding device. For example, the second end of the cover element may be releasably fastened to an inner wall of the cassette, for example can be applied, in particular clamped, in a form-fitting manner on a holding protrusion, a latching nose or a holding groove. Alternatively, the holding device may be a cylindrical shaft. The holding device may be fixed in the cassette. The holding device may be arranged eccentrically in the cassette. The holding device may be arranged offset upward. The holding device may be arranged offset forward. The holding device may have a receptacle for fastening the second end of the cover element. The holding device may be formed integrally with the cassette. The holding device may be formed separately from the cassette.

The cover device may have a plurality of support elements, in particular webs, in each cassette. The cover device may additionally or alternatively have a plurality of rollers, in particular for reducing the friction, as support elements in each cassette. The rollers may be mounted rotatably. The webs or rollers are preferably arranged in the outer corner regions of a cassette, as viewed in the transverse direction. The webs and/or rollers may serve as a guide and/or support for the cover element. The webs or rollers make it possible for the cover element to be steerable in a corresponding round path during the winding up in the cassette. The webs may be formed integrally with the cassette. The rollers may be formed integrally with the cassette. The rollers may be formed integrally with the webs.

The panel may have an outwardly protruding collar region for covering the vehicle floor, for example, for clamping and/or holding down a carpet.

In summary, and in other words, a roller spring may be provided, which can be pulled out of a cassette located at one rail end and which has at least one centering element for centering a movement relative to one of the rails. The roller spring may be guided laterally and above the first rail. The roller spring may be coupled to the second rail (upper rail) so as to follow its movement.

Furthermore preferably, a cassette (receiving chamber) for a roller spring is located in each case at both ends of the rail. Said two roller springs can each be mounted at a first end inside the cassette. The roller springs may have a tendency to relax and always take up a maximum diameter in a rolled-up state. Within the cassette, a position of the roller spring may be predetermined by rollers or webs.

A second end of the respective roller spring may be fastened to, in particular mounted onto, the second rail. When one of the roller springs is pulled, initiated by changing the position of the second rail, the roller spring can be pulled out of the cassette. The roller spring may be unwindable about a mounting with an associated reduction in the diameter of the roller spring. When the second rail is moved back toward the respective cassette, it is possible for the roller spring to be able to be rolled up in the cassette by a spring force of the roller spring. The spring is arranged inside the cassette so as to automatically roll in.

A scraper for dirt, in particular in the form of a brush, which is in contact with the roller spring, may be arranged in the region of an entrance to the cassette and/or within the cassette. A scraper may also be provided so as thus to avoid noises between the rolled-up spring regions.

The proposed solution has the advantage that a continuous panel which has a low number of moving parts is provided.

If a respective cover element in the form of a roller spring is provided to the front and to the rear in the longitudinal direction, the forces in each case acting by the cover elements on the second rail counteract one another, and therefore, apart from the friction in the guides, an adjustment force of the longitudinal adjuster according to the invention, compared to longitudinal adjusters without the cover device described above, is not increased.

One possible method for installing the previously described cover device on one of the previously described rail assemblies or on one of the previously described rail assemblies with combined features in a vehicle may comprise at least the following steps:
providing at least one first rail and at least one second rail, which can be arranged displaceably relative to the first rail, for the longitudinal adjuster,
providing a cover device for covering one of the rails of the longitudinal adjuster, wherein the cover device comprises at least one length-adjustable cover element, which has at least one centering element at a free end,
fastening the cover device to one of the ends of the fixed first rail, with the cover element being placed into a starting position,
fastening the first rail in a vehicle,
arranging the second rail in the first rail, and
displacing the second rail in the direction of the cover device, in particular until the second rail reaches a front end stop of the longitudinal adjuster, with the cover element being centered in the transverse direction during the displacement and thus the coupling by the centering element.

In this case, the cover element and the second rail may have interacting connecting elements, which latch together when the front end stop is reached. This enables the cover device and the longitudinal adjuster to be installed independently and without tools.

Furthermore, the object is achieved according to the invention by a longitudinal adjuster for a vehicle seat, wherein the longitudinal adjuster has at least one of the previously described rail assemblies or one of the previously described rail assemblies having combined features, which comprises at least one first rail and at least one second rail arranged displaceably relative to the first rail, and a cover device. The first rail may be in the form of a long rail which extends in the longitudinal direction of the vehicle and in which a plurality of second rails are arranged in a longitudinally displaceable manner, wherein each pair of second rails are connected to a vehicle seat. In other words: a plurality of seats in a vehicle can be arranged by the longitudinal adjuster so as to be longitudinally movable.

The cover device comprises at least the previously described cover element, which, for example, is connectable or connected via a direct interface and/or via the centering element for automatically coupling to the second rail.

The cover device may have the previously described cassette for receiving and holding the cover element.

The first rail may be a floor rail which can be embedded in a vehicle floor. The first rail may be a floor rail extended in relation to the second rail. The first rail may have a base portion or a web. The first rail may have two legs protruding on opposite sides of the base portion or web. The first rail may have end portions bent back inward at those ends of the legs which are remote from the base portion or web. The first rail may have a substantially U-shaped cross section.

The second rail may have a substantially U-shaped cross section and, conversely, may be arranged in the first rail. The second rail may have a base portion or web from which two opposite legs protrude and form a receiving space between them.

The longitudinal adjuster may have a spindle drive which is arranged between the first rail and the second rail and is suitable for displacing the second rail relative to the first rail. The spindle drive may have a spindle. The spindle may have an external thread. The spindle drive may have a transmission driveable by an electric motor. The transmission may be held in the second rail.

According to a first exemplary embodiment of the spindle drive, the spindle may be held fixed in the first rail by two spindle holders. The spindle may be held fixed against rotating. The transmission may have a spindle nut which has an internal thread and which is operatively connected to the external thread of the spindle. The transmission may be movable along the spindle by being driven by the motor.

According to a second exemplary embodiment of the spindle drive, the spindle may be connected at an end portion of the spindle to the transmission for conjoint rotation. The spindle drive may have a spindle block which is fixed in the first rail and has an internal thread and which is operatively connected to the external thread of the spindle. The spindle may be screwed rotatably into the spindle block. The spindle block may be movable along the driven spindle.

The cover device may be installable, embedded together with the first rail of the longitudinal adjuster, in a vehicle floor, in such a manner that essentially only an upper region of the panel of the cover device and its panel opening are visible in the vehicle. In the covered state of the panel opening, the cover element and the panel are visible in the vehicle. The first rail may be enclosed laterally at least in sections by the panel. The first rail may be covered by the panel. The second rail, which is mounted displaceably in the first rail, can protrude upward out of the opening of the panel in the direction of the vehicle seat.

The guide channel may be in the form of a guide enclosing the first rail (lower rail) and have lateral guide paths in which the cover element, designed for example as a roller spring, is guided laterally. The guide may lie above the first rail and be supported thereon (even if a vehicle occupant treads on the panel).

Furthermore preferably, a cassette, which is in the form, for example, of a receiving chamber or a receiving housing, for a cover element, in particular a roller spring, can be located in each case at both rail ends. These two cover elements can each be mountable at a fixed cover end inside the respective cassette. The cover elements may have a tendency to relax and always take up a maximum diameter in a rolled-up state. Within the cassette, a position of the cover elements may be predetermined by rollers or webs.

The free movable cover end of the respective cover element may be releasably fastenable to, in particular mounted on, the second rail. When one of the cover elements is pulled, initiated by changing the position of the second rail, the cover element may be pullable or pulled out of the cassette. The cover element may be unwindable about a mounting with an associated reduction in the diameter of the cover element. When the second rail is moved back toward the cassette in question, it is possible for the cover element, in particular the roller spring, to be able to be rolled up in the cassette by a spring force. In other words: the cover element, which is in the form of a roller spring, is arranged within the cassette so as to automatically roll in.

The proposed solution has the advantage that a cover device with a continuous panel in the form of the unrollable cover element which has a low number of moving parts is provided.

If a respective cover element in the form of a roller spring is provided to the front and to the rear in the longitudinal direction, the forces in each case acting by the cover elements on the second rail counteract one another, and therefore an adjustment force of a longitudinal adjuster according to the invention, compared to longitudinal adjusters without a cover device according to the invention, is not increased.

The underlying problem is further achieved according to the invention by a vehicle having a longitudinal adjuster according to the above description for at least one vehicle seat or a plurality of vehicle seats in the vehicle.

### FIGURES AND EXEMPLARY EMBODIMENTS OF THE INVENTION

Exemplary embodiments of the invention will be discussed in more detail with reference to drawings. However, the invention is not restricted to these exemplary embodiments. In the drawings:

FIG. 1: shows a schematic illustration of a vehicle seat according to the invention,

FIG. 2: shows part of a perspective illustration of the cover device according to the invention,

FIG. 3: shows part of a longitudinal section of the cover device in the region of a bearing device for a cover element of the cover device,

FIG. 4: shows a side view of a rolled-up cover element with a clamping means and a centering element at a free rolling-up end,

FIG. 5: shows a top view of the rolled-up cover element with two clamping means and two centering elements at the free rolling-up end,

FIG. 6: shows a perspective view of a rolled-up cover element with a clamping means, a centering element and a fastening element at a free rolling-up end,

FIG. 7: shows a side view of a rolled-out cover element with a clamping means and a centering element at a free rolling-up end,

FIG. 8a: shows a cross section through a belt-shaped region of a cover element,

FIG. 9: shows schematically a cross section through a belt-shaped region of a cover element with lateral support regions,

FIG. 10: shows a top view of a cover device in the region of a centering element before installation with a movable rail of a longitudinal adjuster,

FIG. 11: shows a side view of a cover device in the region of a clamping means and a centering element before installation with a movable rail of a longitudinal adjuster,

FIG. 12: shows a cross section of a cover device in the region of a centering element before installation with a movable rail of a longitudinal adjuster,

FIG. 13: shows a top view of a cover device in the region of a centering element after installation with a movable rail of a longitudinal adjuster,

FIG. 14: shows a side view of a cover device in the region of a centering element after installation with a movable rail of a longitudinal adjuster,

FIG. 15: shows a cross section of a cover device in the region of a centering element after installation with a movable rail of a longitudinal adjuster,

FIG. 16: shows a longitudinal section of a cover device installed on a fixed rail of a longitudinal adjuster,

FIG. 17: shows a top view of a cover device installed on a fixed rail of a longitudinal adjuster,

FIG. 18: shows a longitudinal section of a cover device installed on a fixed rail of a longitudinal adjuster prepared for installing on a vehicle,

FIG. 19: shows a top view of a cover device installed on a fixed rail of a longitudinal adjuster prepared for installing on a vehicle,

FIG. 20: shows a longitudinal section of a cover device installed on a fixed rail of a longitudinal adjuster, which is already installed on a vehicle, and during installation of a movable rail on the cover device,

FIG. 21: shows a top view of a cover device installed on a fixed rail of a longitudinal adjuster, which is already installed on a vehicle, and installation of a movable rail on the cover device,

FIG. 22: shows a longitudinal section of a cover device installed on a fixed rail of a longitudinal adjuster, which is already installed on a vehicle, and installed on a movable rail of the longitudinal adjuster,

FIG. 23: shows a top view of a cover device installed on a fixed rail of a longitudinal adjuster, which is already installed on a vehicle, and installed on a movable rail of the longitudinal adjuster,

FIG. 24: shows a longitudinal section of a cover device installed on a longitudinal adjuster,

FIG. 25: shows a top view of a cover device installed on a longitudinal adjuster,

FIG. 26: shows a longitudinal section of a cover device with a rolled-out or unrolled cover element as a result of an adjustment of a movable rail of a longitudinal adjuster,

FIG. 27: shows a top view of a cover device with a rolled-out or unrolled cover element as a result of an adjustment of a movable rail of a longitudinal adjuster,

FIG. 28: shows a longitudinal section of a cover device with two cover elements, wherein two cassettes for two cover elements rolled up in the cassette are installed at ends of a fixed rail of a longitudinal adjuster,

FIG. 29: shows a side view of a cover device with two cover elements, wherein two cassettes for two cover elements rolled up in the cassette are installed at ends of a fixed rail of a longitudinal adjuster,

FIG. 30: shows a longitudinal section of a cover device with two cover elements, wherein two cassettes for two cover elements rolled up in the cassette are installed at ends of a fixed rail of a longitudinal adjuster, before the installation of the fixed rail in a vehicle,

FIG. 31: shows a top view of a cover device with two cover elements, wherein two cassettes for two cover elements rolled up in the cassette are installed at ends of a fixed rail of a longitudinal adjuster, before installation of the fixed rail in a vehicle,

FIG. 32: shows a longitudinal section of a cover device with two cover elements, wherein two cassettes for two cover elements rolled up in the cassette are installed at ends of a fixed rail of a longitudinal adjuster, after the fixed rail has been installed in a vehicle and after the two cover elements have been fastened to a movable rail,

FIG. 33: shows a top view of a cover device with two cover elements, wherein two cassettes for two cover elements rolled up in the cassette are installed at ends of a fixed rail of a longitudinal adjuster, after the fixed rail has been installed in a vehicle and after the two cover elements have been fastened to a movable rail,

FIG. 34: shows, in a schematic illustration, a vehicle seat having a longitudinal adjuster according to the prior art,

FIG. 35: shows, in a perspective illustration, a partial view of a vehicle floor and a vehicle seat, which is adjustable in the longitudinal direction by a rail assembly according to the invention,

FIG. 36: shows, in a perspective illustration, a cover device with a first rail, which is arranged on said cover device, of a rail assembly according to the invention for improved installation,

FIG. 37: shows, in a perspective illustration, a partial view of a direct interface between the cover device and the first rail,

FIG. 38: shows, in a perspective illustration, a further partial view of the direct interface between the cover device and the first rail before automatic coupling,

FIG. 39: shows, in a perspective illustration, a further partial view of the direct interface between the cover device and the first rail during automatic coupling,

FIG. 40: shows, in a perspective illustration, a further partial view of the direct interface between the cover device and the first rail in the coupled state,

FIG. 41: shows, in a perspective illustration, a further partial view of the direct interface between the cover device and the first rail in the coupled state and during closing of a panel opening of the cover device, and

FIG. 42: shows, in a partial sectional illustration, a releasable holding connection of a freely movable cover end in the rolled-up state of the cover element of the cover device.

Parts which correspond to one another are denoted by the same reference signs in all the figures.

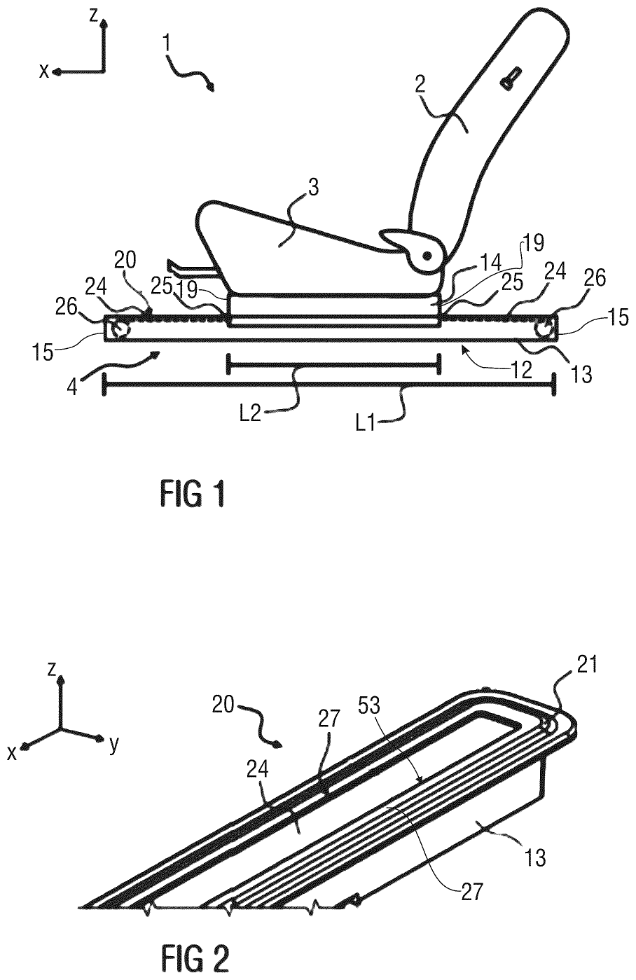

A vehicle seat 1 which is schematically illustrated in FIG. 1 is described below using three spatial directions which run perpendicularly to one another. In the case of a vehicle seat 1 installed in the vehicle, a longitudinal direction x runs largely horizontally and preferably parallel to a vehicle longitudinal direction, which corresponds to the normal direction of travel of the vehicle. A transverse direction y running perpendicularly to the longitudinal direction x is likewise oriented horizontally in the vehicle and runs parallel to a vehicle transverse direction. A vertical direction z runs perpendicularly to the longitudinal direction x and perpendicularly to the transverse direction y. In the case of a vehicle seat 1 installed in the vehicle, the vertical direction z runs parallel to the vehicle vertical axis.

The positional and directional indications used, such as front, rear, top and bottom, relate to a viewing direction of an occupant sitting on the vehicle seat 1 in a normal sitting position, wherein the vehicle seat 1 is installed in the vehicle, in a use position which is suitable for conveying passengers, with an upright backrest 2, and is oriented, as is customary, in the direction of travel. The vehicle seat 1 according to the invention may, however, also be installed in a different orientation, for example transversely with respect to the direction of travel.

The vehicle seat 1, in particular motor vehicle seat, has a seat part 3 and the backrest 2. The backrest 2 is adjustable in its inclination relative to the seat part 3. The vehicle seat 1 has a longitudinal adjuster 4 for adjusting a seat longitudinal position. The longitudinal adjuster 4 has at least one rail assembly 12 having a pair of rails comprising at least one first rail 13 and at least one second rail 14, which is arranged displaceably relative to the first rail 13. The seat part 3 is connected, in particular screwed, to the second rail 14 of the longitudinal adjuster 4. A seat height adjustment device, not illustrated, may also be arranged between the seat part 3 and the second rail 14 of the longitudinal adjuster 4.

The longitudinal adjuster 4 here has a second rail 14 having a length L2, wherein a length L1 of the first rail 13 is greater than the length L2 of the second rail 14, in particular the length L1 of the first rail 13 corresponds to a multiple of the length L2 of the second rail 14. The present longitudinal adjuster 4 is a longitudinal adjuster 4 with an extended adjustment distance compared to a conventional device for longitudinal adjustment of a seat.

The first rail 13 and the second rail 14 of the longitudinal adjuster 4 can form a first pair of rails. The longitudinal adjuster 4 may have a second pair of rails, not shown in the figures for illustrative reasons, which is preferably arranged symmetrically with respect to the first pair of rails. The first rail 13 extends in the longitudinal direction x and has two rail ends 15. The second rail 14 extends in the longitudinal direction x and has two rail ends 19. The first rail 13 is in the form of a floor rail and is longer than the second rail 14. In particular, a plurality of shorter second rails 14 can be arranged in a longitudinally movable manner in the first rail 13.

A cover device 20 is provided for covering open regions of the first rail 13 (lower rail).

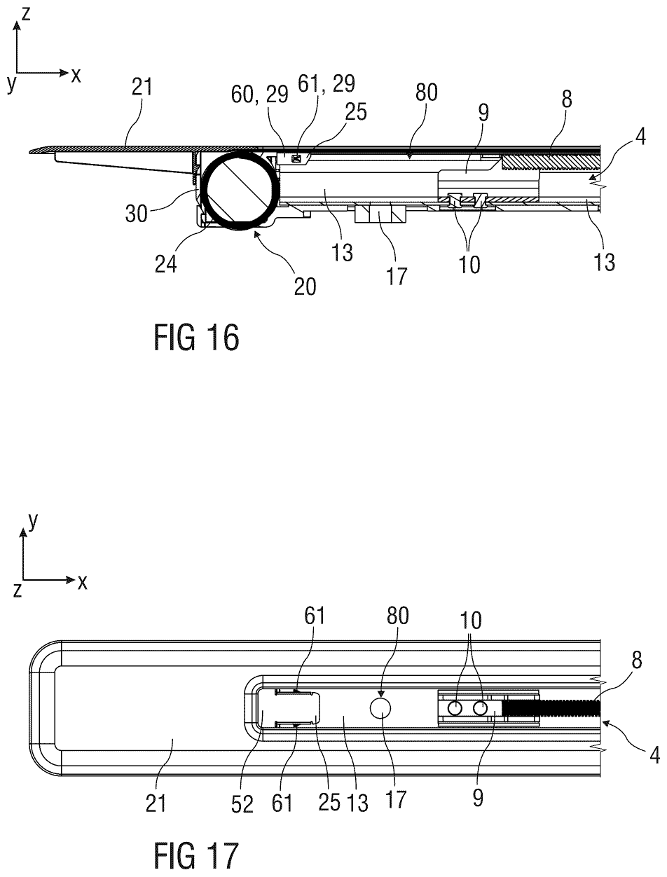

The cover device 20 comprises at least one cover element 24, which covers a region, which is not covered by the second rail 14, of a rail opening 80, shown in more detail in FIGS. 16, 17, 34 and 35, of the first rail 13. For this purpose, the cover element 24 is in the form of an element which can be rolled up in order, during a movement of the second rail 14 relative to the first rail 13, to correspondingly variably cover this first rail, in particular its rail opening 80. In the exemplary embodiment according to FIG. 1, the 30 cover device 20 comprises two cover elements 24, which are each fastened by a first end 25 to the ends of the second rail 14 and are mounted at a second cover end 26 at associated ends of the first rail 13 so as to be able to be rolled up.

FIG. 2 shows part of a perspective illustration of the cover device 20 according to the invention 20.

The first rail 13, in particular a lower rail, comprises a panel 21 in the direction of the second rail 14. The panel 21 is in the form of a panel frame surrounding the, in particular elongate or slot-shaped, rail opening 80 in the first rail 13. The panel 21 rests above or on the first rail 13. By this means, the panel 21 can be supported on the first rail 13. In addition, the panel 21 may also cover side regions of the first rail 13.

The panel 21 may be a plastics element, in particular a plastics panel. The first rail 13 is in particular in the form of a profile component, in particular a metal profile component.

To cover the rail opening 80, the cover device 20 comprises the cover element 24, which is shown in FIG. 2 in the rolled-out state and thus in the state covering the rail opening 80.

The panel 21 may be provided with an integrated, in particular integrally formed, guide channel 27 or a separate guide channel 27. The guide channel 27 may be formed only laterally, in particular on opposite longitudinal sides, of the panel 21.

The guide channel 27 is used to guide the cover element 24 when adjusting the vehicle seat 1. The guide channel 27 is located above or on the first rail 13.

The cover element 24 has an outer edge portion 53. The lateral edge portions 53 of the cover element 24 are guided, for example, by the lateral guide channels 27 of the cover 21 as the cover element 24 is being rolled up or unrolled.

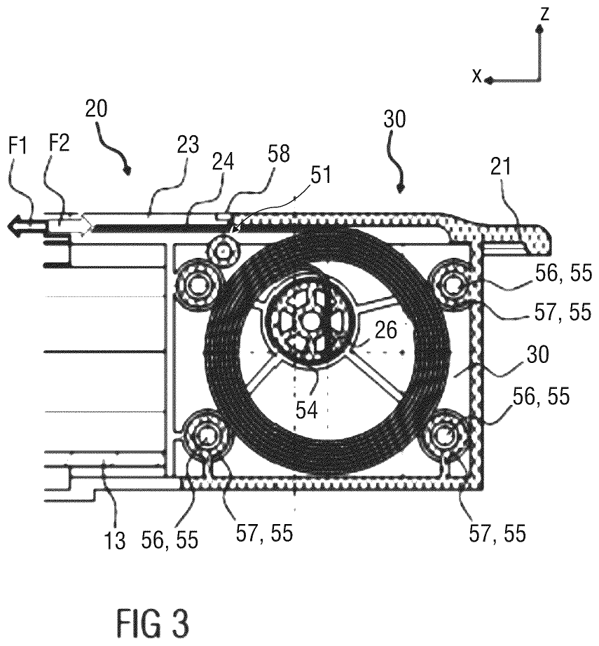

FIG. 3 shows part of a longitudinal section of the cover device 20 in the region of a bearing device, in particular a cassette 30, for receiving the cover element 24 in the rolled-up state.

The cover device 20 here has a first cassette 30, in which a cover element 24 is provided, at a rear end of the first rail 13 in the longitudinal direction x. Preferably, the cover device 20 has a second cassette 30, which is structurally identical to the first cassette 30, but is constructed or arranged mirror symmetrically to the first cassette 30, at a front end of the first rail 13 in the longitudinal direction x. The second cassette 30 has a corresponding additional cover element 24. The following description with reference in general to “the cassette 30” applies both to the first cassette 30 and to the structurally identical second cassette 30.

The cassettes 30 may be arranged on the end faces of the first rail 13. Alternatively, the cassettes 30 may also be arranged within the first rail 13 in its front end and its rear end. Another alternative makes provision for the cover elements 24 to be provided without cassettes 30. For this purpose, for example, corresponding rolling-up elements, in particular rollers, deflection rollers, webs, are arranged, in particular integrated, for example integrally formed, within the first rail 13 at the front end and at the rear end.

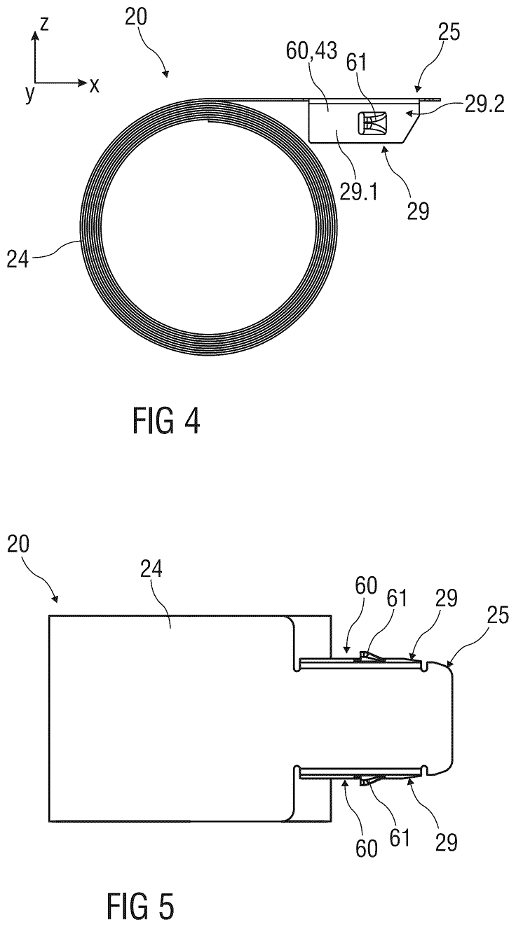

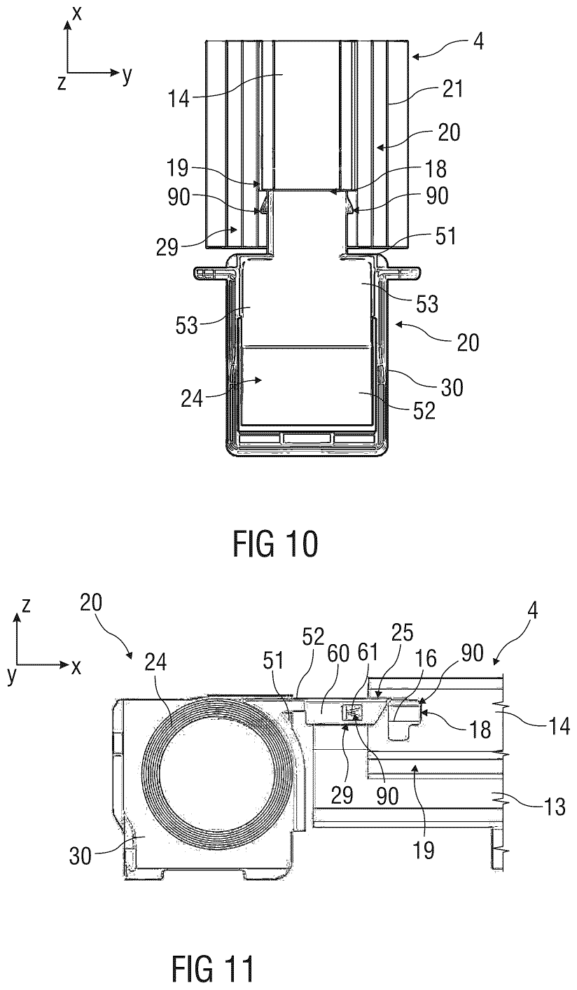

A first end 25 of the cover element 24 shown, inter alia, in FIG. 4 is connected to the second rail 14, in particular is mounted in a receptacle, in particular in a receiving frame 18, shown in FIG. 10, of the second rail 14.

The second cover end 26 of the cover element 24 is connected to a holding device 54 in the cassette 30 assigned to the cover element 24.

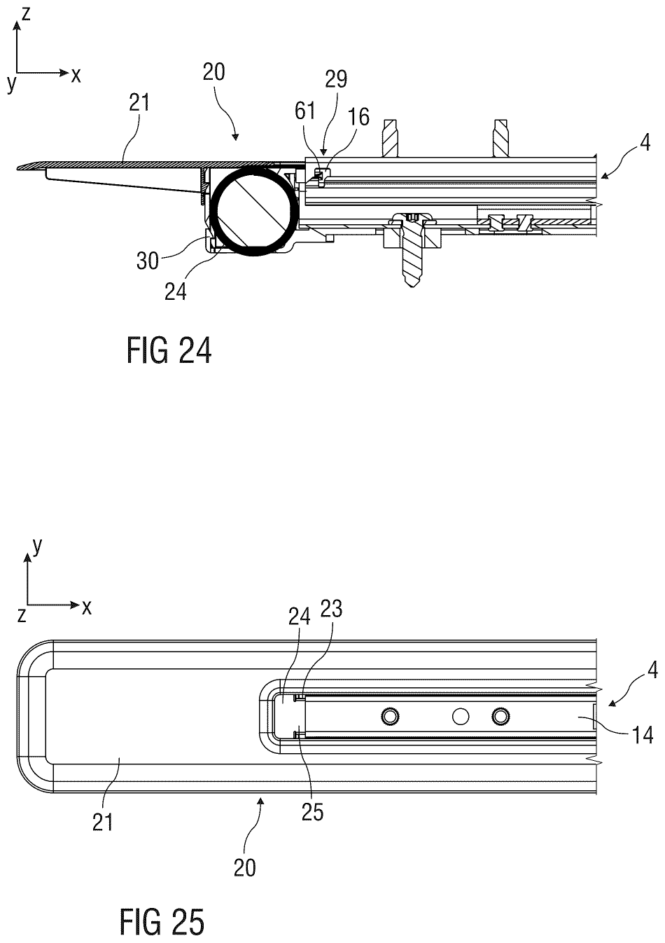

The cover device 20 is used to cover one of the rails 13, 14 of the longitudinal adjuster 4, in particular the first rail 13. The cover device 20 has the panel 21 with an opening 23. The cover device 20 is installable, embedded in a vehicle floor 6, shown in FIG. 24, in such a way that only an upper region of the panel 21 is visible in the vehicle. The panel 21 is an outer plastics panel.

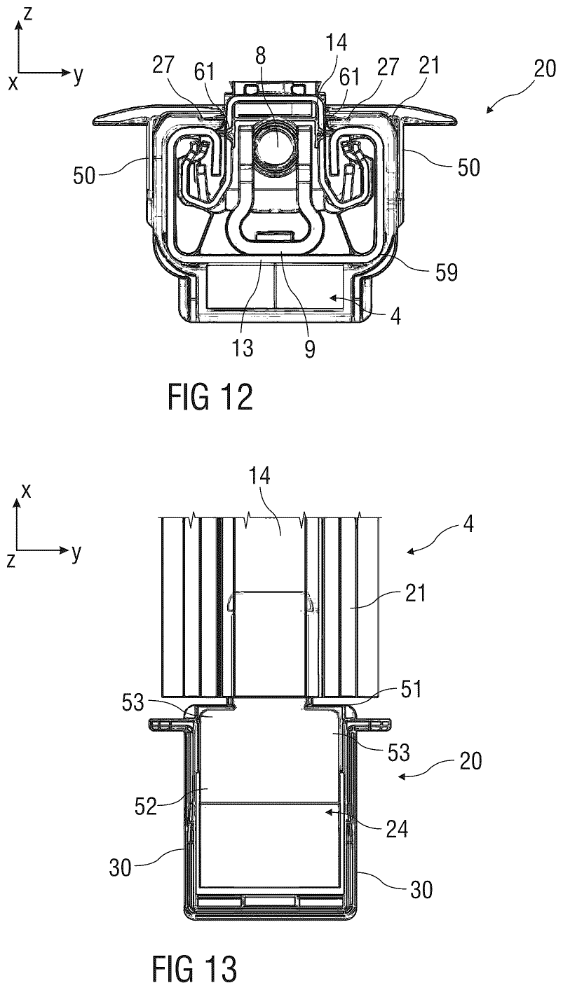

The first rail 13 can additionally be enclosed laterally at least in sections by the panel 21 and covered by it. The second rail 14, which is mounted displaceably in the first rail 13, protrudes upward out of the opening 23 in the panel 21 in the direction of the vehicle seat 1. A guide channel 27 for guiding and holding the respective edge portion 53 of the cover element 24 is arranged on both sides of the opening 23. The guide channel 27 is slot-shaped in the panel 21, as shown in detail in FIG. 12, for example. The two guide channels 27 extend laterally, in particular on both longitudinal sides, of the panel 21 in the longitudinal direction x (illustrated in FIG. 2).

The opening 23 is closable in sections by the cover element 24 guided in the panel 21. By the covering of the opening 23 at least in sections by the cover element 24, a view of a spindle 8, which is arranged in the interior of the first rail 13, of an electrical adjustment can prevented, for example.

The opening 23 in the panel 21 may extend slightly above the cassette 30, as illustrated in FIG. 3. The cassette 30 is substantially closed at the top such that dirt or the like is prevented from penetrating the cassette 30. Furthermore, the fixedly covered cassette 30 has the advantage that the cover element 24 in the cassette 30 cannot be unintentionally pushed downward by external loading.

The cover element 24 is arranged in the respective cassette 30 in a rolled-in or rolled-up state. The panel 21 preferably has a scraper element 58 in an input region of the cassette 30. The scraper element 58 here is a brush. The scraper element 58 is in contact with a surface of the cover element 24. The scraper element 58 thus prevents dirt from penetrating the cassette 30 when the cover element 24 is pulled or pushed into the cassette 30.

The cover element 24 is preferably spring-elastic. The cover element 24 here is configured as a constant force spring, in particular a roller spring.

The holding device 54 here is a cylindrical shaft. The holding device 54 is arranged fixed in the cassette 30. Alternatively or additionally, the holding device 54 may also be mounted rotatably. The holding device 54 is arranged eccentrically in the cassette 30. The holding device 54 has a receptacle for fastening the second cover end 26 of the cover element 24, in particular a slot for the mounting of the second cover end 26.

A number of support elements 55, in particular a plurality of webs 56 with rollers 57 arranged rotatably thereon, is arranged in the cassette 30. The support elements 55 are used to guide and support the cover element 24 as it is being rolled up or unrolled. The webs 56 with the rollers 57 are preferably arranged in corner regions of the cassette 30, as viewed in the transverse direction y. The webs 56 with the rollers 57 are used as a guide or support for the cover element 24. The webs 56 or the rollers 57 make it possible for the cover element 24 to be steerable in a corresponding round path during the rolling-in in the cassette 30.

The cover element 24, in particular in the form of a constant force spring, for example a roller spring, has a tendency to relax and, in a rolled-up state, to always take up a maximum diameter. The cover element 24 is extendable from the cassette 30, in particular through a slot-shaped housing opening 51, by a force F1 introduced by the second rail 14. In the opposite direction, the cover element 24 is retractable or insertable into the cassette 30 by a force F2. The force F2 preferably results from an elastic preload of the cover element 24, which is in the form of a roller spring.

FIG. 4 shows a side view of an exemplary embodiment of a cover element 24. The cover element 24 is in the form of a constant force spring. When the cover element 24 is rolled up, the constant force spring is in the relaxed state. During the partial unrolling of the cover element 24, a force is applied thereto. On being rolled up again, the cover element 24 is again wound up to form a fixed roller.

The cover element 24 is rolled up in FIG. 4 and has an interface 29 at a free end, its first end 25 (also called first cover end 25).

The interface 29 is designed in such a way, during coupling together, that the cover element 24 and the second rail 14 couple to each other under preload and/or, after coupling has taken place, remain or are coupled to each other under preload. The interface 29 comprises at least one clamping means 29.1 at the first cover end 25. The clamping means 29.1 is in the form of a clamping surface 29.2.

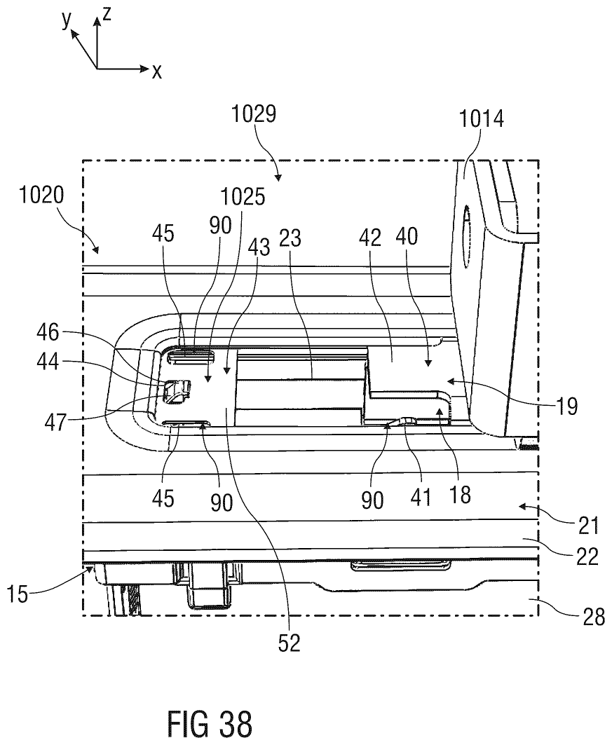

The interface 29 comprises at least one centering element 60 and at least one connecting element 61. The centering element 60 may be in the form of a coupling element 43, shown in FIGS. 37 and 38. Alternatively or optionally additionally, the connecting element 61 may be in the form of a coupling element 43. At least one connecting element 61, in particular in the form of a coupling element 43, may be arranged, in particular integrally formed, on the centering element 60.

The interface 29 is provided between the cover element 24 and the second rail 14 for automatically coupling the cover element 24 to the second rail 14, wherein the interface 29 comprises at least the coupling element 43 and the centering element 60. A mating coupling element 40, which can be brought into latching engagement with the coupling element 43 and is shown in FIGS. 37, 38, 39 and 40, is arranged at the rail end 19 of the second rail 14.

The interface 29 comprises a number of corresponding latching elements 90 which are shown, inter alia, in FIG. 10 and enter into a releasable latching engagement during the installation. The latching elements 90 are provided on the coupling element 43 and on the mating coupling element 40.

The interface 29, in particular the centering element 60, serves for the interaction of the cover device 20 and the second rail 14 during a movement of the second rail 14 relative to the cover device 20, in particular during an installation movement of said second rail. The centering element 60 at the first end 25 of the cover element 24 can also make it possible for the second rail 14 to be able to be coupled and connected in a simple manner without tools and automatically to the cover element 24. For example, during a movement of the second rail 14 relative to the cover element 24, for example during installation or during conventional use of the second rail 14, for example during an adjustment of a seat, the second rail 14, on reaching the cover element 24, can couple to the latter. During this coupling movement, the cover element 24 is guided centered by the centering element 60 in the transverse direction y (Y centering), also see FIGS. 10 to 15.

In an installed state, the centering element 60 is arranged within a receiving space 18, which is formed by the second rail 14 and is shown, inter alia, in FIG. 37, and is connected in a form-fitting and/or force-fitting manner to the second rail 14, in particular to a rail end 19 of the second rail 14. In other words: the interface 29 fulfills two separate functions: firstly, the centering elements 60, in particular laterally deployed lugs or tabs, are used for a Y alignment of the cover element 24 when coupling to the second rail 14. Secondly, the connecting elements 61, in particular latching noses on the laterally deployed lugs or tabs, are used for the coupling of the cover element 24 to the second rail 14, in particular to a corresponding latching element 90 (illustrated in FIG. 11), for example a latching opening.

The centering element 60 is in the form of a bent-over tab, lug or tongue. In particular, the centering element 60 is in the form of a region or portion of the first end 25, which is separated by a longitudinal section and bent over.

The connecting element 61 is used in particular for fastening the cover element 24 to the movable second rail 14. For example, the connecting element 61 is a latching nose.

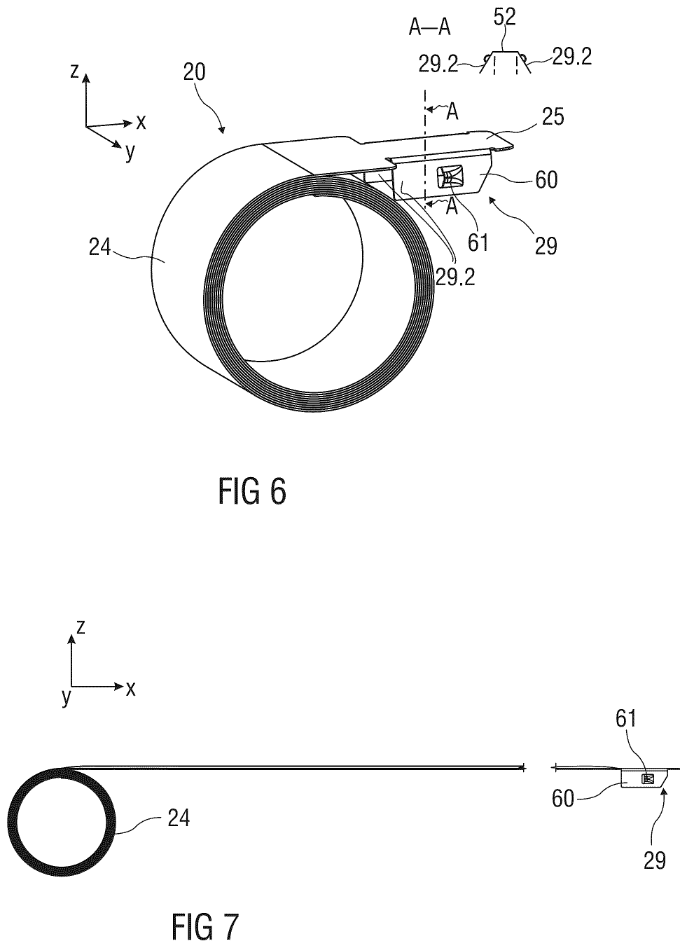

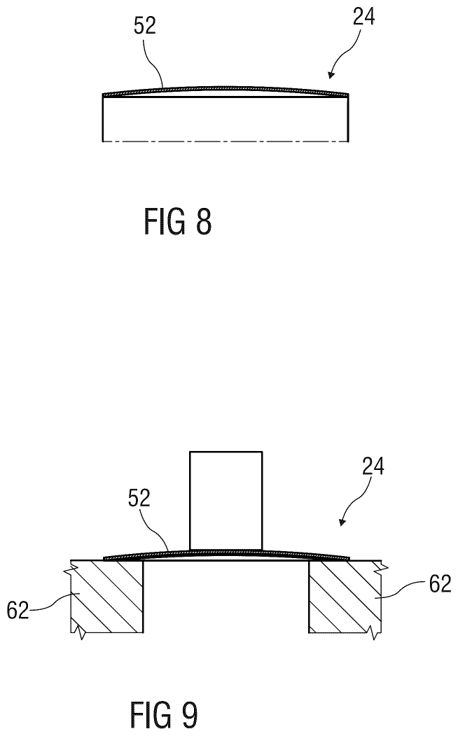

In one exemplary embodiment, two tabs of the cover element 24, in particular at the first cover end 25 of the constant force spring, in particular the roller spring, are bent over laterally. The respective tab (also called lug or tongue) is in the form of a region or portion separated from the cover element 24 by a longitudinal section and laterally partially bent over downward. These tabs form the clamping surfaces 29.2 at the first cover end 25. In this case, the tabs, as seen in the cross section of the cover element 24, can be bent downward in such a way that they stand up or protrude outward in relation to an outer perpendicular line to the belt region 52 (shown in FIGS. 6 and 8), illustrated in the sectional illustration A-A in FIG. 4. For example, the tabs are bent downward about 85° such that they stand up 5° in relation to the vertical or 95° in relation to the belt region 52.

In other words: The two clamping surfaces 29.2, in the form of the tabs, which are designed as a pair of clamping means 29.1 at the first cover end 25, protrude laterally in the transverse direction y over the rail end 15 (shown in FIG. 1) of the second rail 14 both in the installed state of the second rail 14 and cover element 24 and in the uncoupled state of the cover element 24 and second rail 14. As a result, the clamping surfaces 29.2 formed by the tabs lie preloaded on the inner sides of the second rail 24 in the assembled state or in the coupled state of the cover element 24 and second rail 14.

In this case, the cover element 24 and the second rail 14 can be coupled to each other under preload in the coupled state by the clamping surfaces 29.2 in such a way that a belt region 52 (illustrated in FIGS. 6 and 8) of the cover element 24 is in the form of an upwardly projecting curved surface. Thus, the belt region 52 can be formed in particular in a manner free from undulations or free from creases. In other words: the belt region 52 has a homogeneously curved surface.

During the coupling or in the coupled state of the cover element 24 and the second rail 14, the two clamping surfaces 29.2 engage laterally in the second rail 14 in such a way that the cover element 24 and the second rail 14 are coupleable to each other, or remain coupled or are coupled, under preload.

In the region of the two tabs, latching noses or hooks are deployed as connecting elements 61, which then engage in corresponding cutouts of the second rail 14, in particular of the movable rail or upper rail.

The centering elements 60 in the form of tabs are not formed parallel to the inner surfaces of the second rail 14, but rather stand up slightly more. In this example, the centering elements 60 stand up at 95 degrees. By this means, during and/or after the installation, a preload is achieved which permits a fixed connection of the cover element 24 and permits the surface in the end region thus to arch upward as in the belt region 52 of the cover element 24, in particular the roller spring. This results in a homogeneous curvature without undulating regions.

In order to permit automatic installation of the cover element 24, the two bent centering elements 60, in particular tabs, are supported in the x direction on the housing of the panel 21, in particular on a longitudinal facing of the first rail 13 or on a covering 59 (illustrated in FIG. 15) of the first rail 13. The first end 25 of the cover element 24, in particular the roller spring, may also have insertion slopes, which allow a y centering of the cover element 24 relative to the second rail 14, the upper rail profile, during the coupling.

After the installation of the second rail 14, also called seat rail, in the vehicle, said second rail 14 has to be only adjusted once into the end positions of the adjustment region, in order to automatically couple there to the connecting element 61 of the cover element 24, in particular to lock together. This can be done, for example, during a normal function check.

FIG. 5 shows a top view of the rolled-up cover element 24 with two lateral interfaces 29 at the first end 25. The respective interface 29 comprises a centering element 60 and a connecting element 61. In addition, the first cover end 25 may be oblique or rounded such that centering of the cover element 24 is possible when coupling to the second rail 14. In other words: the first cover end 25 with rounded or oblique corners acts as the primary centering and the centering element 60 in the form of deployed oblique side tabs acts as the secondary centering when coupling the cover element 24 and the second rail 14 to each other.

At the first end 25, two bent-over tabs are provided as centering elements 60. In the region of each centering element 60, at least the connecting element 61 is provided.

FIG. 6 shows a perspective view of the rolled-up cover element 24 with the centering element 60 as a separate and bent-over tab and with the fastening element 16 or connecting element 61.

FIG. 7 shows a side view of a rolled-out cover element 24 with the interface 29 and the centering element 60 and the connecting element 61 at the free end, in particular the first end 25. The cover element 24 as a constant force spring comprises a belt region 52, in particular a thin, belt, which is able to be rolled up or coiled, in particular a spring belt or steel belt, for example in the manner of a measuring tape or a thin, coiled steel belt.

FIG. 8 shows a cross section through the belt region 52, in particular through a belt-shaped region, of the cover element 24. At least the belt region 52 has a curved shape in cross section. The belt region 52 of the cover element 24 has a bulge in cross section. The bulge in the transverse direction y can extend in some regions or completely over the length of the cover element 24.

FIG. 9 shows schematically a cross section through the belt region 52 of the cover element 24 in a region in which the cover element 24 is supported laterally. For this purpose, support elements 62 are provided. The support elements 62 may be formed separately. For example, said support elements 62 may be arranged laterally to the first rail 13. Alternatively, said support elements 62 may also be part of the panel 21, for example in the form of support blocks protruding downward in the direction of the second rail 14.

FIG. 10 shows a top view of the cover device 20 and the longitudinal adjuster 4 before they are coupled to each other. The first end 25 of the cover element 24 is already arranged within the second rail 14 and has brought about a first centering of the cover element 24 relative to the second rail 14. The centering element 60 has not yet been introduced into the second rail 14, the movable rail. The interface 29 of the cover element 24 for coupling to the second rail 14 comprises the two lateral connecting elements 61. The cover element 24 is arranged rolled up in the cassette 30. The first end 25 of the connecting element 61 is arranged in front of the second rail 14 and is not yet coupled thereto.

The cover device 20 comprises the panel 21, which is arranged laterally along the second rail 14. In the belt region 52, the cover element 24 comprises edge portions 53, which are insertable in the panel 21 in the guide channel 27 (illustrated in FIG. 2 or 12) and are guideable therein during an adjustment of the second rail 14 relative to the first rail 13 in order to cover the latter.

FIG. 11 shows a side view of the cover device 20 before installation on the movable, in particular second, rail 14 of the longitudinal adjuster 4. The first end 25 of the cover element 24 and the centering element 60 have not yet been inserted into the second rail 14, the movable rail. Likewise, the connecting element 61 is not yet in engagement with the second rail 14.

FIG. 11 shows an alternative, in particular captive, mounting of the cover element 24 in the cassette 30.

The first end 25 of the cover element 24 can be connected, as described above, to the second rail 14. For the captive arrangement of the cover element 24 in the cassette 30, the cover element 24 has a corresponding length, which is longer than a predetermined required unrolling length for covering the first rail 13. In this case, a second end 26 of the cover element 24 may be arranged unfastened in the cassette 30. The cover element 24 as a constant force spring is held because of its restoring force in a rolled-up state in the cassette 30.

In addition, the spring force of the cover element 24 is dimensioned such that the cover element 24 is mounted captively in the cassette 30 even as it is being unrolled or rolled up. Furthermore, the cassette 30 may have such a shape and/or dimensions at least on the inside that the cover element 24 is mounted captively in the cassette 30 both in the rolled-up state and as it is being rolled up or unrolled. For example, the cassette 30 may have, on the inside, support elements 55, in particular arcuate protrusions 29 and/or webs 56, for guiding and supporting the cover element 24 in the cassette 30. The cassette 30 comprises a housing with the housing opening 51 which is directed in the direction of the upper second rail 14, in particular the slot-shaped housing opening 51, through which the free end 25 of the cover element 24 is led out. The housing opening 51 is dimensioned such that the cover element 24 is mounted captively in the cassette 30 both in the fully rolled-up state and in the unrolled state with a predetermined unrolling length.

Alternatively or additionally, the cover element 24, in particular the second end 26 of the cover element 24, may be held in the cassette 30 by a fastening or the previously described holding device 54. For example, the second end 26 of the cover element 24 may be releasably fastened to an inner wall of the cassette 30, for example may be applied, in particular clamped, in a form-fitting manner on a holding protrusion, a latching nose or a holding groove.

The second rail 14 comprises fastening elements 16, in particular latching recesses or cutouts, corresponding to the connecting elements 61, at the end 19 facing the cover device 20. The fastening elements 16 are part of the mating coupling element 40. The connecting elements 61 and the fastening elements 16 are in the form of mutually corresponding latching elements 90.

FIG. 12 shows a cross section of the cover device 20 and of the longitudinal adjuster 4.

The cover device 20 has the panel 21 with the opening 23. The cover device 20 is installable, embedded in a vehicle floor 6, in such a way that only an upper region of the panel 21 is visible in the vehicle. The panel 21 is an outer plastics panel.

The first rail 13 can additionally be enclosed laterally at least in sections by the panel 21 and covered by it. For this purpose, the panel 21 comprises extensions 50 protruding vertically in the direction of the first rail 13. The extensions 50, for example in the form of walls, extend laterally in the longitudinal direction x, in particular on both longitudinal sides, of the first rail 13.

In this case, the respective guide channel 27 may be integrally formed on the underside of the panel 21. Alternatively, as illustrated, the cover device 20 may comprise, in addition to the panel 21, a partial covering 59 for the first rail 13, which covering serves, for example, as a side cover and/or bottom cover and, for example, is arranged laterally and on the bottom side of the first rail 13 and below the panel 21. At that end of the covering 59 which is directed toward the panel 21, the guide channel 27 may be in the form of a longitudinal groove or a cutout, as illustrated.

The spindle 8 is arranged in the region between the first rail 13 and the second rail 14 using a bracket 9.

FIG. 13 shows a top view of the cover device 20 after installation with the cover element 24 with the movable, second rail 14.

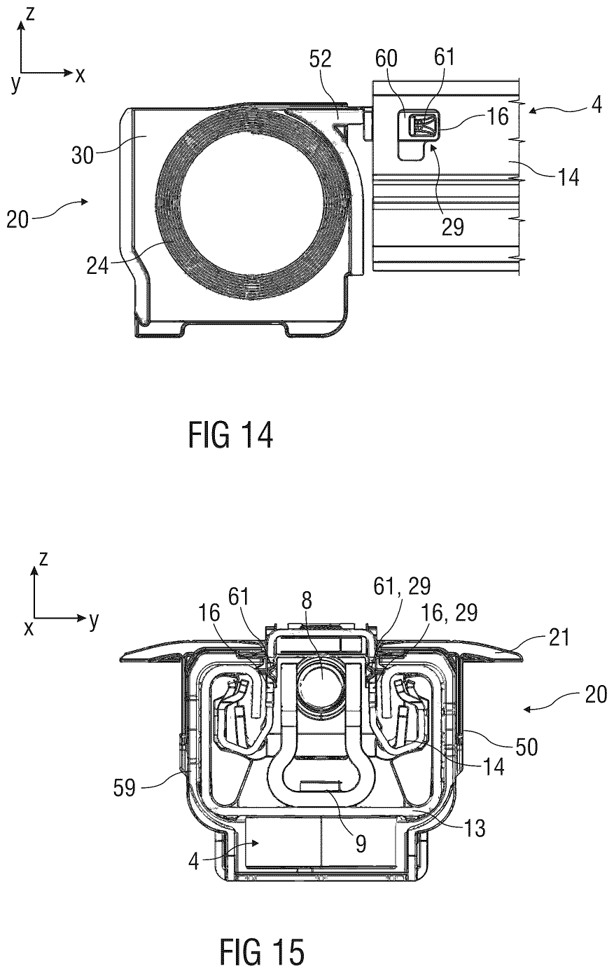

FIG. 14 shows a side view of the cover device 20 on the second rail 14 according to FIGS. 12 and 13 and thus after installation with the movable, second rail 14.

The connecting element 61 for fastening the cover element 24 to the movable, second rail 14 is latched with or latched in the corresponding fastening element 16, in particular a latching recess or cutout. Thus, the cover element 24 and the second rail 14 are coupled to each other. The cover element 24 is coupled to the second rail 14 via the direct interface 29. In particular, the connecting elements 61 interlock with the fastening elements 16.

FIG. 15 shows a cross section of the cover device 20 coupled to the second rail 14.

FIG. 16 shows a longitudinal section of the cover device 20 pre-assembled on the fixed, first rail 13 of the longitudinal adjuster 4. FIG. 16 shows the delivery position of the cover device 20.

The second rail 14 has an adjustment distance with a length of, for example, 500 mm to 800 mm, in particular of 600 m. The long adjustment distance means that the spindle 8 with a length of almost 700 mm is not covered over the entire adjustment region of the second rail 14 by the rail profile thereof. This may lead to soiling of the spindle 8 and may potentially lead to a malfunction. To avoid this, the cover element 24 covers the gap or the opening 23 in the panel 21 of the first rail 13.

During installation of the first rail 13 in the vehicle, the cover device 20, in particular the cover element 24, has to be opened, in particular rolled up, to have access to the screw-on points for the fastening means 17 (in particular through openings) in the vehicle floor 6, as illustrated in FIG. 17. For example, the bracket 9 of the spindle 8 comprises two fastening bolts 10.

FIG. 17 shows a top view of the cover device 20 installed on the fixed, first rail 13 of the longitudinal adjuster 4.

Owing to the direct interface 29 of the cover element 24 (roller spring) and the second rail 14 (upper rail or seat rail or movable rail), the invention permits automatic installation of the cover element 24 on the second rail 14, as is described in more detail below. A stud bolt for the cover element 24 is omitted here.

The cover element 24 has, as a constant force spring, in particular roller spring, a continuous curved surface in the transverse direction y, as illustrated in FIGS. 8 and 9. Damage to the guide tracks and/or the guide channel 27 can be largely avoided here. In addition, the interface 29 has a short constructional form.

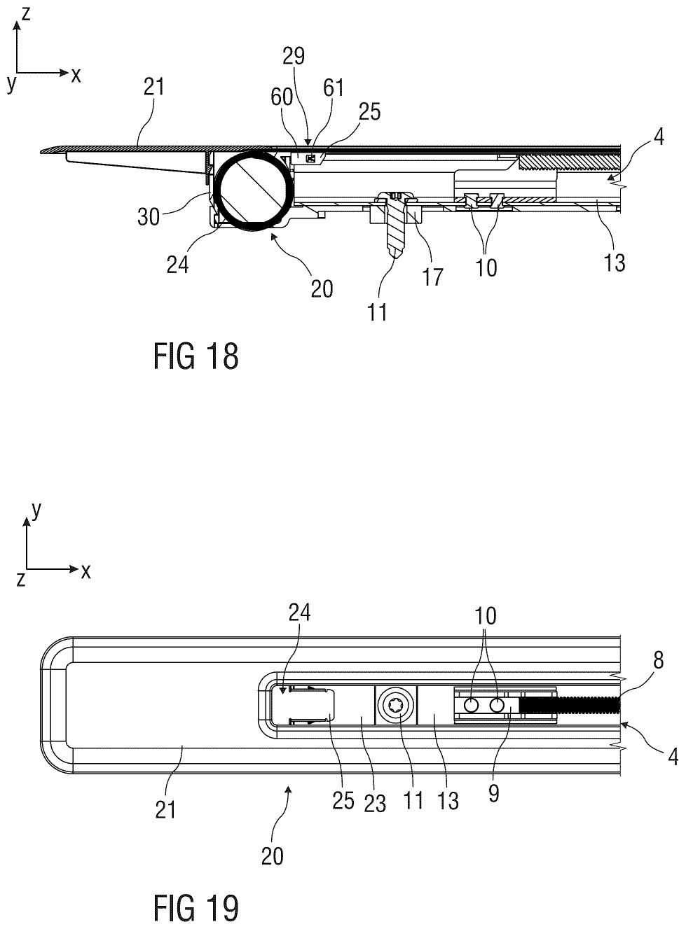

FIG. 18 shows a longitudinal section of the cover device 20 installed on the fixed, first rail 13. The first rail 13 is screwed to the vehicle by a screw 11.

FIG. 19 shows a top view of the cover device 20 installed on the fixed, first rail 13, which in turn is installed on the vehicle by the screw 11.

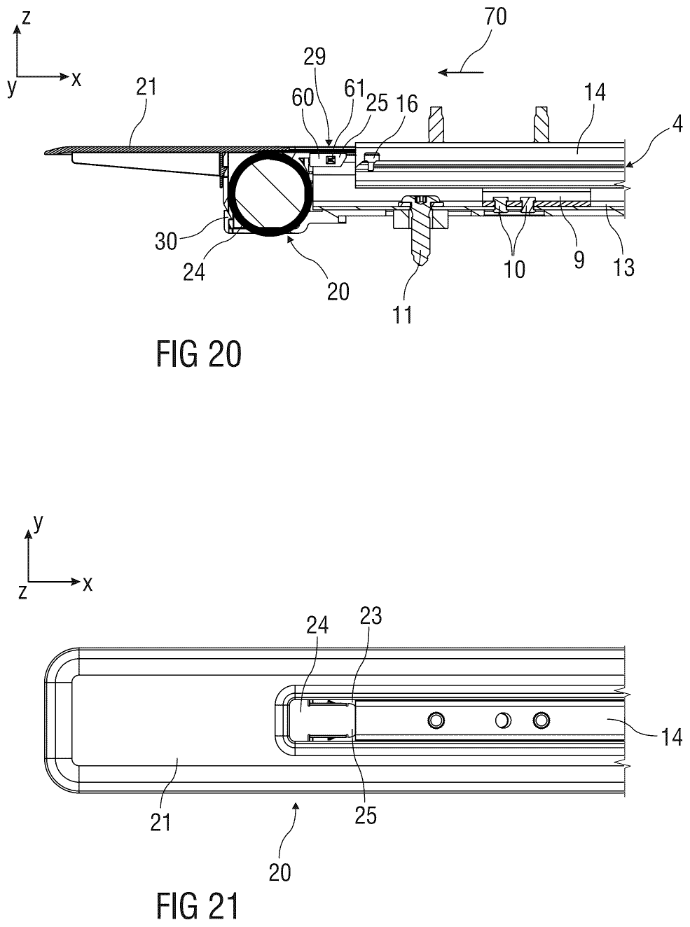

FIG. 20 shows a longitudinal section of the cover device 20 installed on the fixed, first rail 13, which is already installed on the vehicle by the screw 11. For the automatic installation of the cover device 20 and the longitudinal adjuster 4, the movable, second rail 14 is moved in the direction of the cover device 20, in particular in the direction of the end 25 of the cover element 24, in particular the constant force spring, according to arrow 70.

FIG. 21 shows a top view of the cover device 20 according to FIG. 20 and installed on the fixed, first rail 13, which is already installed on the vehicle, and in preparation for the automatic installation with the movable, second rail 14.

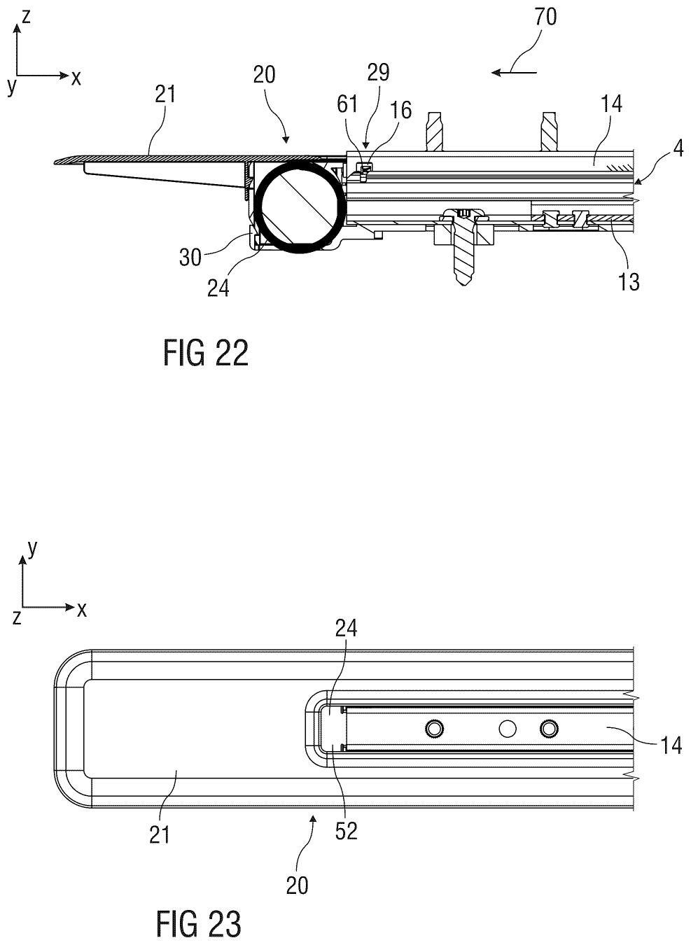

FIG. 22 shows a longitudinal section of the cover device 20 installed on the first rail 13 and the second rail 14. For the automatic coupling of the cover device 20 and the second rail 14, the movable, second rail 14 (upper rail) is moved as far as an end stop, with the connecting element 61 and the corresponding fastening element 16 coupling to each other, in particular latching together. As a result, the cover element 24, in particular the constant force spring, and the second rail 14 are coupled to each other.

For example, the latching position of the interface 29 may be overrun by several millimeters according to arrow 70 in order to be able to compensate for tolerances and to permit secure coupling, in particular latching.

FIG. 23 shows a top view of the cover device 20 according to FIG. 22.

FIG. 24 shows a longitudinal section of the cover device 20 installed on the longitudinal adjuster 4.

The second rail 14 is moved away from the end position and grips against the connecting elements 61, in particular the latching noses, of the cover element 24, in particular a constant force spring, such as a roller spring.

FIG. 25 shows a top view of the cover device 20 installed with the longitudinal adjuster 4 according to FIG. 24.

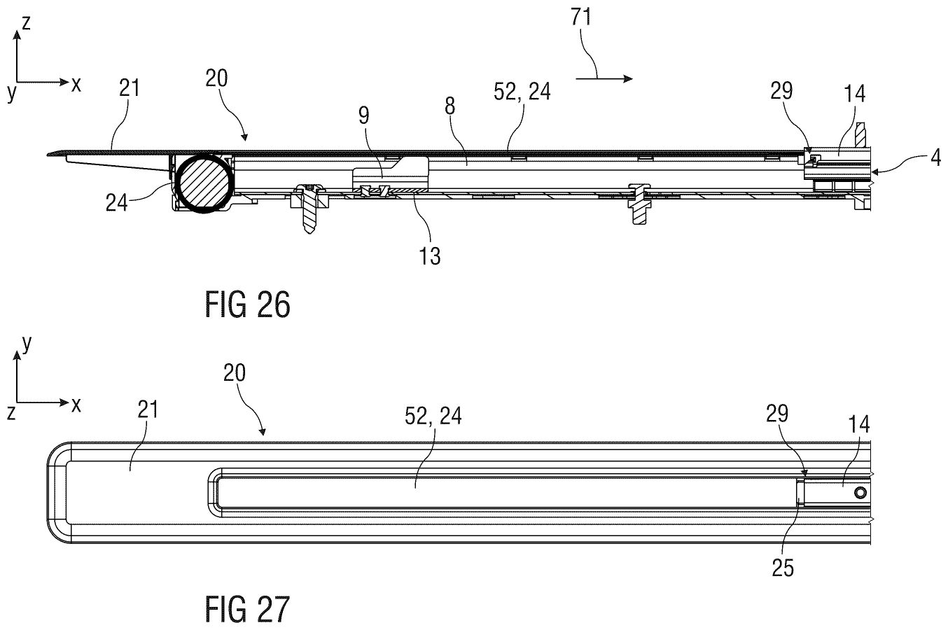

FIG. 26 shows a longitudinal section of the cover device 20 with the cover element 24 rolled out or unrolled as a result of an adjustment of the movable, second rail 14 relative to the first rail 13 and away from the cassette 30 in the longitudinal direction x according to arrow 71.

FIG. 27 shows a top view of the cover device 20 with the cover element 24 rolled out or unrolled as a result of the adjustment of the second rail 14 according to FIG. 26.

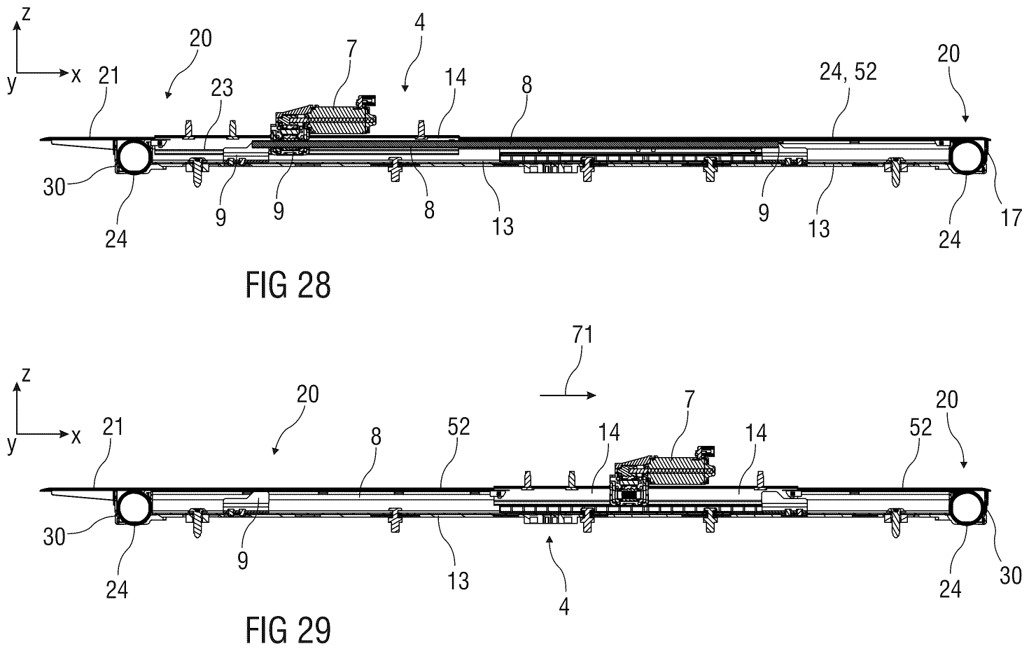

FIG. 28 shows a longitudinal section of a cover device 20 with two cover elements 24, wherein two cassettes 30 each having a rolled-up cover element 24 are installed at the ends of the first rail 13. The spindle 8 is driven by a drive 7, in particular an electric motor, in order to adjust the second rail 14 in the longitudinal direction x relative to the first rail 13. In FIG. 28, the second rail 14 is positioned to the left, the cover element 24, in particular its belt region 52, of the right cassette 30 is rolled out to the maximum and covers the corresponding opening 23 in the first rail 13. The cover element 24 of the left cassette 30 is arranged rolled up therein.

FIG. 29 shows a further side view of the cover device 20 with two cover elements 24. In this case, the second rail 14 is partially adjusted to the right, and therefore both the right cover element 24 in the right cassette 30 and the left cover element 24 in the left cassette 30 are partially unrolled. The two cover elements 24, in particular the belt regions 52 thereof, each cover the associated portion of the opening 23 in the first rail 13.

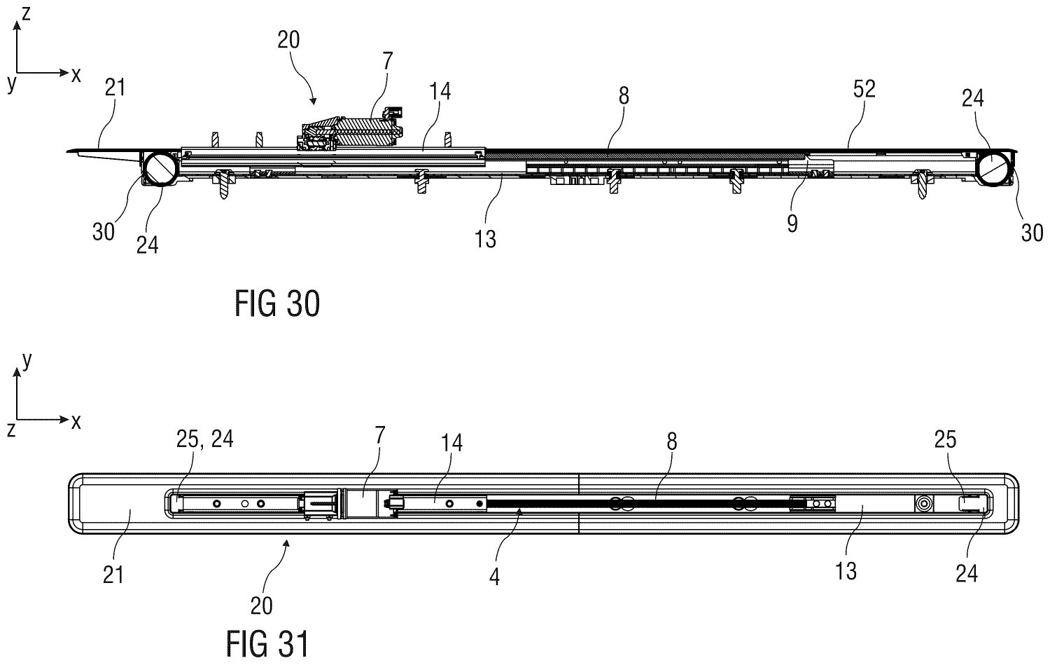

FIG. 30 shows a longitudinal section of the cover device 20 with two cover elements 24, wherein two cassettes 30 are installed at the ends of the first rail 13. The right cover element 24 is not yet coupled to the second rail 14, and therefore the right portion of the opening 23 in the panel 21 is freely accessible, as shown in FIG. 31.

FIG. 31 shows a top view of the cover device 20 with the two cover elements 24 according to FIG. 30. The spindle 8 is visible in the right portion of the free opening 23.

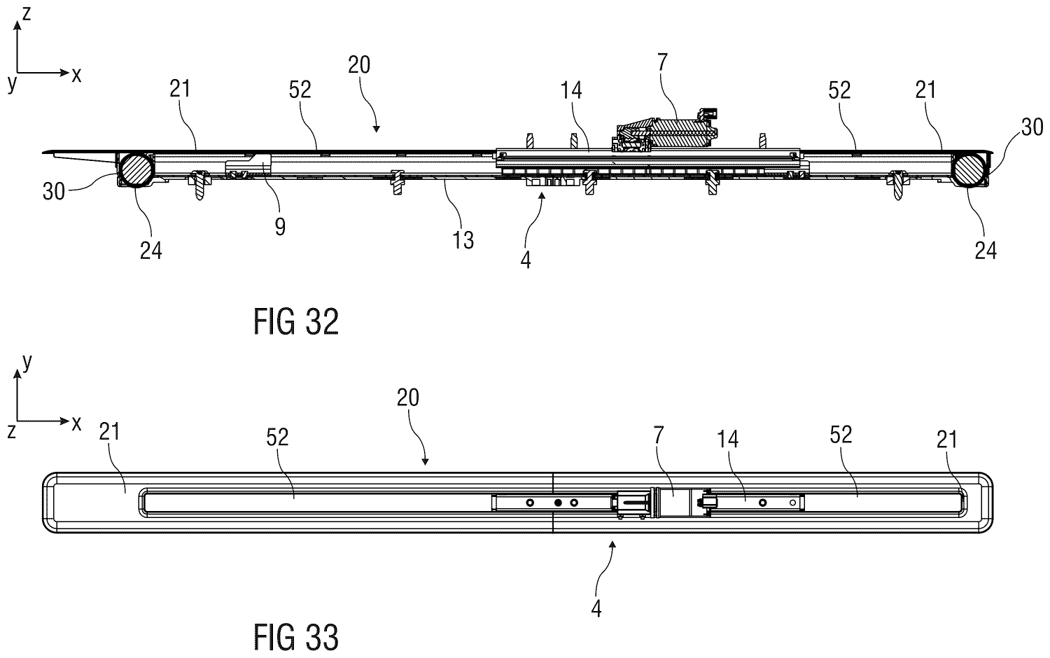

FIG. 32 shows a longitudinal section of the cover device 20 with the two cover elements 24 with an adjusted second rail 14, both cover elements 24 having been coupled to the second rail 14 beforehand. The two cover elements 24, in particular the belt regions 52 thereof, are extended, in particular unrolled, in sections to cover associated portions of the opening 23 in the first rail 13. The spindle 8 is no longer visible, as can be seen in FIG. 33.

FIG. 33 shows the top view of the cover device 20 according to FIG. 32.

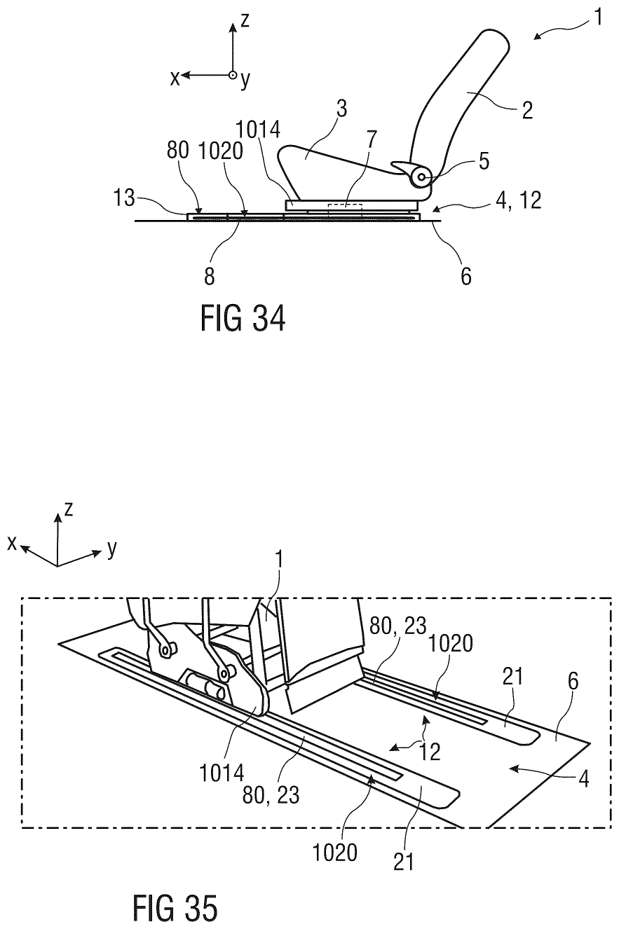

FIG. 34 shows, in a schematic illustration, a vehicle seat 1 having a longitudinal adjuster 4 according to the prior art. A backrest 2 can be arranged pivotably on a seat part 3 of the vehicle seat 1. For this purpose, the vehicle seat 1 may comprise a fitting 5, in particular a rotary fitting, such as for example a latching fitting or tumble fitting.

The first rail 13, which is fixedly fastened to the vehicle floor 6, has a greater length than the second rail 1014, which is fastened to the seat part 3. By this means, the vehicle seat 1 can be adjusted relative to the vehicle floor 6 over a large adjustment distance, for example over a length of 600 mm, in the longitudinal direction x.

The vehicle seat 1 is, for example, adjustable in the longitudinal direction x by an electric drive element 7, in particular a spindle drive, for adjusting the second rail 1014 relative to the first rail 13 and the vehicle floor 6. For this purpose, a spindle 8 is arranged within the first rail 13. For this purpose, the first rail 13 has a rail opening 80, which is open in particular upward in the direction of the second rail 1014.

To cover open regions of the first rail 13 and to avoid soiling the spindle 8 in the first rail 13, a cover device 1020 is provided over the upwardly open rail opening 80.

FIG. 35 shows, in a perspective illustration, a partial view of the vehicle floor 6 and the vehicle seat 1, which is adjustable in the longitudinal direction x by the rail assembly 12 according to the invention. The first rail 13 (illustrated in FIG. 1 or 34), in particular a lower rail, comprises the rail opening 80, through which the first rail 13 is fastenable to the vehicle floor 6.

The cover device 1020 can be installable, embedded together with the first rail 13 of the longitudinal adjuster 4 in the vehicle floor 6, in such a manner that substantially only an upper region of the cover device 1020, in particular a panel 21 of the cover device 1020 and the panel opening 23 thereof, is visible in the vehicle.

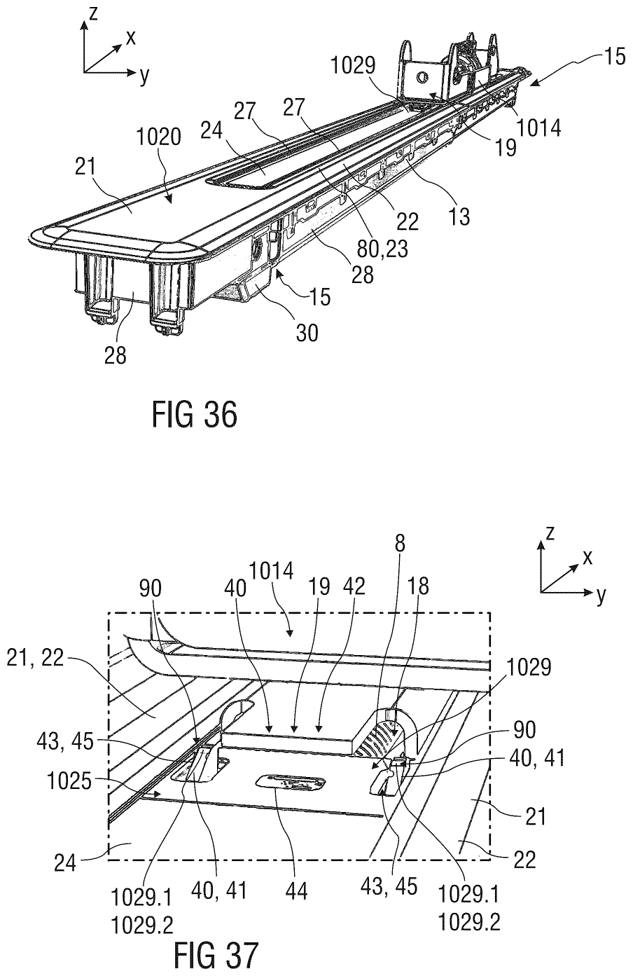

FIG. 36 shows, in a perspective illustration, the cover device 1020, on which the second rail 1014 is arranged for improved automatic installation of the cover device 1020 on the rail assembly 12.

The cover device 1020 comprises the at least one panel 21 with the panel opening 23 and a cover element 24 which can be rolled up. The panel 21 and the cover element 24 are constructed analogously to the cover device 20.

The cover device 1020 is arranged on the first rail 13 in such a way that the rail opening 80 and the panel opening 23 lie one above the other, wherein the panel opening 23 is closable at least in sections by the cover element 24, which is guided in lateral guide channels 27 of the panel 21 and can be rolled up, and is shown closed in FIG. 36. The guide channel 27 may be in the form of a guide surrounding the first rail 13, analogously, for example, as per FIGS. 1 to 33. For example, lateral guide tracks, in which the cover element 24 is guided laterally, can be provided in each case along the longitudinal sides of the panel opening 23 as a guide channel 27 for the cover element 24.

The cover element 24 is in the form, for example, of an element which can be rolled up, in particular a roller spring, in order, during a movement of the second rail 1014 relative to the first rail 13 (illustrated in FIGS. 1 and 34), to correspondingly variably cover said first rail, in particular the rail opening 80 thereof. The first rail 13 is concealed by panel side walls 28 in FIG. 36.

In one possible exemplary embodiment, the cover device 1020 may comprise just one cover element 24. In an alternative exemplary embodiment, the cover device 1020 may comprise at least two cover elements 24.

For example, a cassette 30 (receiving chamber) for the cover element 24, in particular a roller spring, may be arranged in each case at at least one rail end 15 or both rail ends 15 of the first rail 13 or at at least one end or both ends of the panel 21. The one cover element 24 or the two cover elements 24 are each mountable on, in particular rotatably fastened to, a fixed cover end 26 within the cassette 30. The respective cover element 24 may have a tendency to relax and, in a rolled-up state, to always take up a maximum diameter within the cassette 30.

In the covered state of the panel opening 23, the cover element 24 and the panel 21 are visible in the vehicle. The first rail 13 may be surrounded laterally at least in sections by the panel 21, for example via panel side walls 28 protruding vertically from the panel 21. The first rail 13 may also be covered in the direction of the second rail 1014 by the panel 21, in particular a panel frame 22 surrounding the panel opening 23.

The second rail 1014, which is displaceably mounted in the first rail 13, can preferably protrude upward out of the panel opening 23 in the direction of the vehicle seat 1.

For an automatic coupling of the cover device 1020 to the second rail 1014, a direct interface 1029, which is described in more detail below, is provided between them:

FIG. 37 shows, in a perspective illustration, a partial view of the direct interface 1029 between the cover device 1020 and the second rail 1014 for automatically coupling them to each other.

The direct interface 1029 may have a pair of clamping means 1029.1, in particular two clamping contours 1029.2, which, when the second rail 1014 and the cover element 24 are in the installed or coupled state in the first rail 13 and the cover element 24 and the second rail 14 are in the uncoupled state, protrude (upward) in the vertical direction x over the cover element 24.

During the coupling (upon coupling) or in the coupled state of the cover element 24 and the second rail 1014, the two clamping contours 1029.2 engage from below (from below in the vertical direction z) in the cover element 24, in particular in latching openings 45 in the cover element 24, in such a way that the cover element 24 and the second rail 1014 are coupleable to each other, or remain coupled or are coupled, under preload.

The interface 1029 comprises at least one coupling element 43 at at least one freely movable cover end 1025 of the cover element 24 and at least one mating coupling element 40, at a rail end 19 of the second rail 1014 facing the freely movable cover end 1025, for automatically coupling to the coupling element 43 during installation of the cover device 1020 and second rail 1014.

The cover element 24 comprises, as coupling element 43, at least one latching receptacle 44 for releasably fixing the freely movable cover end 1025 in the rolled-up state and at least one, preferably two latching openings 45 for releasably fixing the mating coupling element 40 to the freely movable cover end 1025.

The latching receptacle 44 is in the form of an elongate slot, which extends in the transverse direction y. The latching openings 45 are each in the form of an elongate slot, which extends in the longitudinal direction x. The latching receptacle 44 is arranged between the two latching openings 45.

The second rail 1014 comprises, as mating coupling element 40, at least two latching hooks 41 which, in the coupled state of the interface 1029, latch releasably into the latching openings 45. In addition, the second rail 1014 comprises, as mating coupling element 40, a cover 42 which protrudes from the rail end 19 in the longitudinal direction x and covers a holding element 46, which is illustrated in FIG. 38, in the coupled state of the cover element 24 and the second rail 1014. In this case, the cover 42 can prevent unintentional decoupling of the cover element 24.

Alternatively or additionally, the cover 42 may also be in the form of a triggering means which releases or opens the fixing of the cover element 24 in the rolled-up state when the cover device 1020 and the second rail 1014 are coupled. As a result, when the cover device 1020 and the second rail 1014 are coupled and the fixing of the rolled-up cover element 24 is released, the cover element 24 can participate in the movement of the second rail 1020.

FIG. 38 shows, in a perspective illustration, a further partial view of the direct interface 1029 between the cover device 1020 and the second rail 1014 before an automatic coupling of the coupling element 43 and mating coupling element 40.

The clamping contours 1029.2 at the rail end 19 extend away from the rail end 19 and upward in the vertical direction z. The clamping contours 1029.2 have a height in the vertical direction z such that they protrude both over the belt region 52 of the cover element 24 and over the panel frame 22 in the vertical direction z. The clamping contours 1029.2 have an increasing gradient in the direction of the rail 1014. This makes it easier to retract the clamping contours 1029.2 during the coupling under the belt region 52. In this case, the preload increases in accordance with the rising clamping contour 1029.2 when the rail 1014 and thus the clamping contours 1029.2 are retracted under the cover element 24.

The interface 1029 comprises a number of corresponding latching elements 90 which enter into a releasable latching engagement during the installation. The latching elements 90 are provided on the coupling element 43 and on the mating coupling element 40.

A holding element 46 for fixing the freely movable cover end 1025 in the rolled-up state of the cover element 24 is arranged in a latching manner in the latching receptacle 44.

The holding element 46 is in the form of, for example, a flexible holding element or a holding spring (illustrated in FIG. 42). A holding hook 47 protruding from the holding element 46 protrudes through the latching receptacle 44. In particular, the holding hook 47 is mounted in a form-fitting manner in the latching receptacle 44. The cover element 24 which is in the form of a roller spring pulls the edge of the latching receptacle 44 against the holding element 46, in particular the holding hook 47, to fix the initial position.

For the fixing, the holding hook 47 is pushed or pressed into the latching receptacle 44, for example, during the assembly, and thus locked in the latching receptacle 44. A spring force of the holding element 46 ensures that the latter is kept preloaded in the latching receptacle 44. A spring force of the holding element 46, which is in the form, for example, of a roller spring, ensures that the connection is maintained. The cover element 24 is fixed in the rolled-up state by the latched-in holding element 46.

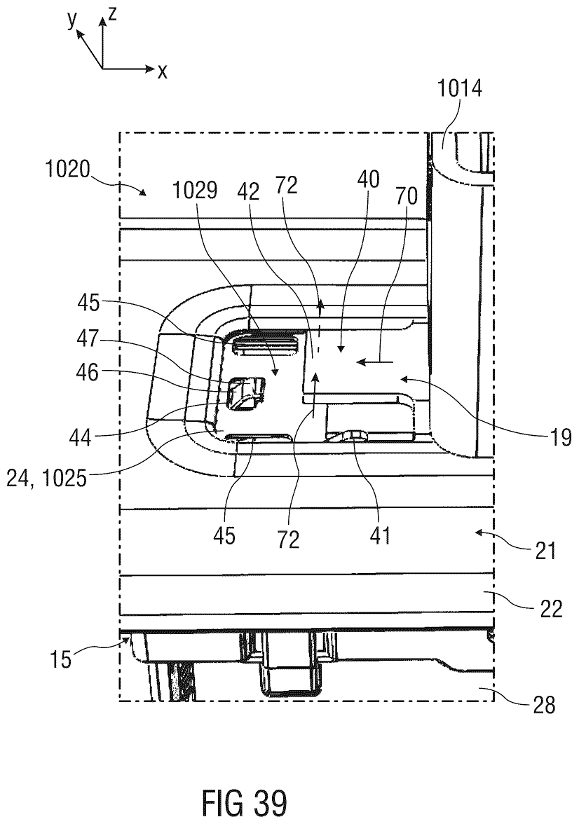

FIG. 39 shows, in a perspective illustration, a further partial view of the direct interface 1029 between the cover device 1020 and the second rail 1014 during automatic coupling. For this purpose, the second rail 1014 is moved according to arrow 70 in the direction of the rolled-up cover element 24 with the releasably fixed, freely movable cover end 1025.

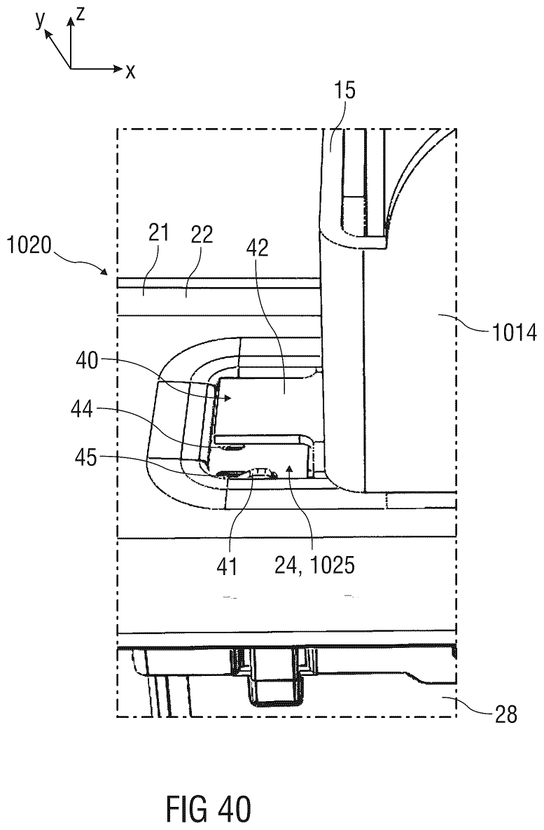

In this process, the latching hooks 41, which protrude from the rail end 19 in the longitudinal direction x, are moved under the freely movable cover end 1025 until the latching hooks 41 engage in a latching manner in the latching openings 45, as shown in FIG. 40. The cover end 1025 is raised in the vertical direction z according to arrow 72 owing to the contour of the latching hooks 41, before the latching hooks 41 latch into place. Said contours of the latching hooks 41 form the previously described clamping contours 1029.2.

In order to fix the coupling of the latching hook 41 and cover end 1025, the latching hooks 41 pass automatically or indirectly actively upward in order to enter into latching engagement in the respectively associated latching opening 45, in particular laterally arranged through opening in the freely movable cover end 1025. When the second rail element 1014 moves away from the rail end 15 of the first rail element 13, the second rail element 1014 pulls the edge of the latching openings 45 against the latching hooks 41 to fix the coupling, in particular a carry-along position of the cover element 24.

When the latching hooks 41 engage in the latching openings 45, a cover 42 passes at the same time into a position covering the holding element 46, in particular the holding hook 47. As soon as the cover element 24, after coupling to the second rail 1014, is carried along, in particular is extended, as a result of the movement of the second rail 1014, the holding hook 47 passes out of the latching engagement in the latching receptacle 44. The 20) holding element 46 relaxes in the process. In particular, the holding element 46 moves downward automatically, for example by spring force. As shown in FIG. 42, the holding element 46 in the partially or fully extended state is arranged below the cover element 24. In particular, the holding element 46 remains in said relaxed position lying below the cover element 24 until the cover element 24 is brought again into a rolled-up state in which the holding hook 47 latches into the latching receptacle 44 and thus fixes the cover element 24.

In an alternative or additional exemplary embodiment, the cover 42 may be in the form of a triggering means (not illustrated). For example, a cover 42 in the form of a triggering means can release the holding element 46 from the latching engagement on the cover element 24. For this purpose, the cover 42, which is formed in the form of a triggering means, enters into engagement with the holding element 46 and pushes the latter out of the releasable engagement in the latching receptacle 44. As a result, the cover element 24 is released and free to be carried along by the second rail 1014 owing to the coupling to the second rail 1014 by the latching engagement of the latching hooks 41 in the latching openings 45 in the cover element 24, as shown in FIG. 40.

FIG. 40 shows, in a perspective illustration, a further partial view of the direct interface 1029 between the cover device 1020 and the second rail 1014 in the coupled state thereof and in the released state of the cover element 24 to be freely carried along.

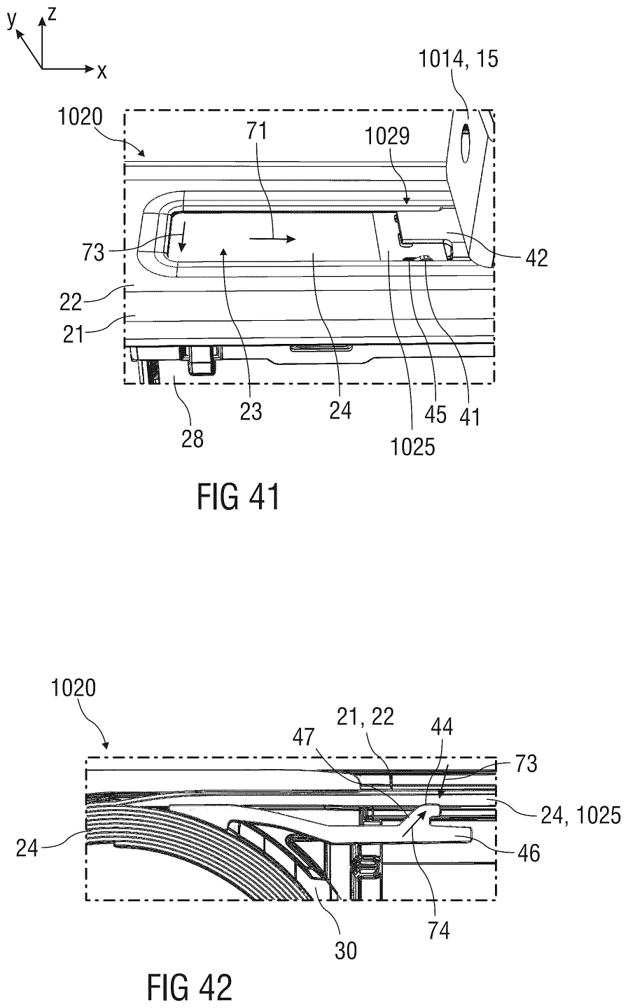

FIG. 41 shows, in a perspective illustration, a further partial view of the direct interface 1029 between the cover device 1020 and the second rail 1014 in the coupled state and during closing of the panel opening 23 in the cover device 1020 by the released cover element 24, which, in the event of a movement of the second rail 1014 away from the rolled-up cover element 24 in the longitudinal direction x, is carried along owing to the previously described coupling of the cover element 24 and the second rail 1014 according to arrow 71 in order to close the panel opening 23.

After the automatic or indirect release of the holding element 46 (illustrated in FIG. 39), in particular of the holding hook 47, from the latching engagement in the latching receptacle 44 (illustrated in FIG. 39), said holding element is automatically moved away from the cover element 24 according to arrow 73. For this purpose, the holding element 46 is in the form, for example, of a latching spring or elastic latching tongue or flexible hook, which is preloaded in the latching engagement in the latching receptacle 44 and relaxes when released from said latching engagement and thus moves the holding element 46 automatically into a rest position.

FIG. 42 shows, in a partial sectional illustration, the releasable holding connection of the holding element 46 of the freely movable cover end 1025 in the partially rolled-out state of the cover element 24.

During the movement of the second rail 1014 (illustrated in FIG. 41) with the cover element 24 coupled to the interface 1029 (illustrated in FIG. 41), the holding element 46, in particular a flexible holding hook 47 or latching tongue, which is fastened to the cassette 30 and secures the initial position and fixing of the rolled-up cover element 24, moves out of the holding engagement according to arrow 73, in particular downward, and remains in said out-of-engagement position. Arrow 74 shows an insertion direction in which the holding element 46, in particular the holding hook 47, was previously inserted for engagement in the latching receptacle 44 for automatically installing the upper rail with the cover element 24.

After the automatic or indirect release of the holding hook 47 from the engagement position in the latching receptacle 44 of the cover element 24 (illustrated in FIGS. 38 and 39), the holding element 46 lies below the cover element 24. In this position of the holding element 46 below the cover element 24 there always remains a small gap or a small distance between the cover element 24 (also called a roll-forming cover) and the flexible holding element 46, in particular the holding hook 47, and therefore the cover element 24 can be unrolled, in particular extended, easily and safely and in particular without friction with respect to the holding element 46. For this purpose, the holding element 46 is designed in such a way that it is arranged in its relaxed, in particular out-of-engagement position, below the cover element 24 at a predetermined distance from the cover element 24.

For adjusting the receiving position of the freely movable cover end 1025 (also called cover), the holding element 46, in particular the holding hook 47, is actively moved upward in order to bring it into the latching receptacle 44, in particular into a centrally arranged through opening in the freely movable cover end 1025. The cover element 24 which is in the form of a roller spring pulls the edge of the latching receptacle 44 against the holding element 46, in particular the holding hook 47, to fix the initial position.

The features disclosed in the above description, in the claims and in the drawings may be of significance both individually and in combination for the realization of the invention in its various embodiments. The described features of the respective exemplary embodiments may be of importance individually and in combination for the realization of the invention in various embodiments.

Although the invention has been described in detail in the drawings and in the above illustration, the illustrations are to be understood as being illustrative and exemplary and non-restrictive. In particular, the selection of the proportions of the individual elements illustrated in the drawing is not to be interpreted as being necessary or restrictive. Furthermore, the invention is in particular not restricted to the exemplary embodiments discussed. Further variants of the invention and of the embodiment thereof emerge for a person skilled in the art from the preceding disclosure, from the figures and from the claims.

Expressions such as “comprise”, “have”, “include”, “contain” and the like used in the claims do not exclude further elements or steps. The use of the indefinite article does not exclude a plurality. A single device may perform the functions of a plurality of the units or devices mentioned in the claims.

### LIST OF REFERENCE SIGNS

1 Vehicle seat
2 Backrest
3 Seat part
4 Longitudinal adjuster
5 Fitting
6 Vehicle floor
7 Electric drive element
8 Spindle
9 Bracket
10 Fastening bolt
11 Screw
12 Rail assembly
13 First rail
14, 1014 Second rail
15 Rail end of the first rail
16 Fastening element
17 Fastening means
18 Receiving space
19 Rail end of the second rail
20, 1020 Cover device
21 Panel
22 Panel frame
23 Panel opening
24 Cover element
25, 1025 First cover end
26 Second cover end
27 Guide channel
28 Panel side walls
29, 1029 Interface
29.1, 1029.1 Clamping means
29.2 Clamping surface
1029.2 Clamping contour
30 Cassette
40 Mating coupling element
41 Latching hook
42 Cover
43 Coupling element
44 Latching receptacle
45 Latching opening
46 Holding element
47 Holding hook
50 Extension
51 Housing opening
52 Belt region
53 Edge portion
54 Holding device
55 Support element
56 Web
57 Roller
58 Scraper element
59 Covering
60 Centering element
61 Connecting element
62 Support element
70 Arrow
71 Arrow
72 Arrow
73 Arrow
74 Arrow
80 Rail opening
90 Latching element
F1 Force
F2 Force
L1 Length of the first rail
L2 Length of the second rail
x Longitudinal direction
y Transverse direction
z Vertical direction

1-15. (canceled)

16. A rail assembly for a longitudinal adjuster of a vehicle seat, the longitudinal adjuster, comprising:
one first rail,
one second rail, which is arranged displaceably relative to the first rail, and
a cover device for covering a rail opening of the first rail,
wherein the cover device comprises at least one cover element, which closes the rail opening at least in sections upon a movement of the second rail relative to the first rail,
wherein an interface is provided between the cover element and the second rail for automatically coupling the cover element to the second rail,
wherein the interface is designed in such a way that, during coupling together, the cover element and the second rail couple to each other under preload and/or, after coupling has taken place, remain or are coupled to each other, under preload.

17. The rail assembly as claimed in claim 16,
wherein the interface comprises a pair of clamping means either at a first cover end of the cover element or at a rail end of the second rail.

18. The rail assembly as claimed in claim 17,
wherein a first interface at the first cover end has, as the pair of clamping means, two clamping surfaces which, when the second rail and the cover element are in the installed or coupled state and in the uncoupled state of the cover element and the second rail, protrude laterally over the rail end of the second rail in the transverse direction.

19. The rail assembly as claimed in claim 18,
wherein the cover element and the second rail are coupled to each other under preload in the coupled state by the clamping surfaces in such a way that a belt region of the cover element is in the form of an upwardly projecting curved surface.

20. The rail assembly as claimed in claim 18,
wherein, during the coupling or in the coupled state of the cover element and the second rail, the two clamping surfaces engage laterally in the second rail in such a way that the cover element and the second rail are coupleable to each other, or remain coupled or are coupled, under preload.

21. The rail assembly as claimed in claim 17,
wherein a second interface at the rail end has, as the pair of clamping means, two clamping contours which, when the second rail and the cover element are in the installed or coupled state and in the uncoupled state of the cover element and the second rail, protrude over the cover element in the vertical direction.

22. The rail assembly as claimed in claim 21,
wherein, during the coupling or in the coupled state of the cover element and the second rail, the two clamping contours engage from below in the cover element in such a way that the cover element and the second rail are coupleable to each other, or remain coupled or are coupled, under preload.

23. The rail assembly as claimed in claim 16, wherein the cover element is in the form of a preloaded roller spring.

24. The rail assembly as claimed in claim 16, wherein at least one cassette is provided, with the cover element being arranged so as to be able to be rolled up into the latter or unrolled out of it, wherein a first cover end of the cover element that is able to be led or is led out of the cassette is connectable or connected to the second rail.

25. The rail assembly as claimed in claim 16, wherein the interface has at least one coupling element and a mating coupling element, wherein a cover end is provided with the coupling element and a rail end of the second rail facing the cover end is provided with the mating coupling element.

26. The rail assembly as claimed in claim 25, wherein the interface has a number of corresponding latching elements, which enter into a releasable latching engagement during the installation.

27. The rail assembly as claimed in claim 16, wherein a cover end of the cover element and/or at least one centering element for aligning the cover element relative to the second rail during installation are/is provided.

28. The rail assembly as claimed in claim 27, wherein the cover end is wedge-shaped or obliquely rounded and/or the centering element is in the form of a bent-over tab, lug or tongue.

29. The rail assembly as claimed in claim 16, wherein the rail assembly and the longitudinal adjuster are in at least one vehicle seat in a vehicle.

30. A vehicle comprising the longitudinal adjuster as claimed in claim 16.
